(19) United States
(12) Patent Application Publication
(10) Pub. No.: US 2014/0006158 A1
(43) Pub. Date: Jan. 2, 2014

(54) PROVIDING CROSS-CHANNEL OPT-IN, MANAGEMENT AND ADVERTISING

(71) Applicant: Bradley Gregg COOPER, Irvine, CA (US)

(72) Inventor: Bradley Gregg COOPER, Irvine, CA (US)

(21) Appl. No.: 13/799,489

(22) Filed: Mar. 13, 2013

Related U.S. Application Data
(60) Provisional application No. 61/667,032, filed on Jul. 2, 2012.
(60) Provisional application No. 61/693,840, filed on Aug. 28, 2012.
(60) Provisional application No. 61/735,821, filed on Dec. 11, 2012.
(60) Provisional application No. 61/765,761, filed on Feb. 17, 2013.

(51) Int. Cl. G06Q 30/02

(52) U.S. Cl. CPC G06Q 30/0258
USPC 705/14.56

(57) ABSTRACT

An opt-in system. The system includes a subscription network including at least tangible computing elements, one or more interfaces for users to access the subscription network and to provide information for receipt by at least one of a plurality of entities that interact with or operate the subscription network, and one or more interfaces between the subscription network and the plurality of entities that interact with or operate the subscription network. The information received by a first entity that interacts with or operates the subscription network is used to deliver a communication, information or offer to at least one of the users from a second entity that interacts with or operates the subscription network, with the first entity different from the second entity.

### CROSS-REFERENCE TO RELATED APPLICATIONS

This application claims the benefit of the following U.S. Provisional Patent Applications: Application No. 61/667,032 filed Jul. 2, 2012, titled “METHODS AND SYSTEMS FOR PROVIDING PHONE CALL-BASED OPT-IN TO EMAIL COMMUNICATIONS”; Application No. 61/693,840, filed Aug. 28, 2012, titled “METHODS AND SYSTEMS FOR PROVIDING PHONE CALL-BASED LINKING OF USER PROFILES ON SOCIAL NETWORKS”; Application No. 61/735,821, filed Dec. 11, 2012, titled “METHODS AND SYSTEMS FOR PROVIDING APP-TO-PHONE CALL LINKS AND FEATURES TO APP USERS CALLING PHONE NUMBERS IN A NETWORK”; and Application No. 61/765,761, filed Feb. 17, 2013, titled “PROVIDING CROSS-CHANNEL OPT-IN, MANAGEMENT AND ADVERTISING.”

### BACKGROUND

The present disclosure generally relates to providing users and/or consumers with opt-in and/or opt-in management across various channels, call-related features, account management and/or other features and also providing networks of users, advertising opportunities, content management and/or other features to various entities. For example, the present disclosure relates to permitting a consumer to opt-in via phone calls and/or sign-up forms; and/or to receive communications, information or offers such as content, features, advertising, or discounts delivered via various channels such as email, telephone, online, social media profiles, search engine ads, banner ads, ad re-targeting, email ads, cookie-based ads, in applications and/or other channels created by and/or distributed by various networks, businesses, individuals, organizations and/or other entities.

### SUMMARY

In one aspect, the subject technology provides an opt-in system. The system includes a subscription network including at least tangible computing elements, one or more interfaces for users to access the subscription network and to provide information for receipt by at least one of a plurality of entities that interact with or operate the subscription network, and one or more interfaces between the subscription network and the plurality of entities that interact with or operate the subscription network. The information received by a first entity that interacts with or operates the subscription network is used to deliver a communication, information or offer to at least one of the users from a second entity that interacts with or operates the subscription network, with the first entity different from the second entity.

In another aspect, the subject technology provides access to a subscription network that permits at least one user to opt-in to receive communications, information or offers from entities that interact with or operate the subscription network. The method includes the steps of providing one or more interfaces to the subscription network for at least one user, at least one of a plurality of entities that interact with or operate the subscription network to communicate with the user, or both; receiving information provided by the user for receipt by at least a first entity of the plurality of entities that interact with or operate the subscription network; and providing the information for receipt by at least a second entity of the plurality of entities that interact with or operate the subscription network, with the second entity different from the first entity.

In a further aspect, the subject technology permits at least one user to opt-in to receive communications, information or offers from entities that interact with or operate a subscription network. The method includes the step of receiving information from the user through an interface to the subscription network, the information for receipt by at least a first entity of the plurality of entities that interact with or operate the subscription network to communicate with users. The method also includes the step of transmitting at least one of the communications, information or offers from a second entity that interacts with or operates the subscription network to the user, with the first entity different from the second entity.

This brief summary has been provided so that the nature of the invention may be understood quickly. A more complete understanding of the invention may be obtained by reference to the following description in connection with the attached drawings.

### BRIEF DESCRIPTION OF THE DRAWINGS

FIG. 1 is a high-level block diagram showing an example environment and system with example components and groups of components; for example a subscription network and its components, users and user groups, entities and entity groups, computing devices, databases, software, networks, flows, connections and other systems and components.

FIG. 2 is a high-level block diagram further illustrating some components in FIG. 1, such as an example environment and system with example components for an interactive voice response (“IVR”) and phone tree engine.

FIG. 3 is a high-level block diagram further illustrating some components in FIG. 1, such as an example environment and system with example components for an opt-in engine.

FIGS. 4, 4A, 4B, 4C, 4D, 4E, 4F and 4G are generally flow diagrams illustrating various example process flows performed via various components and providing various features; for example phone-related and/or phone call session features, opt-in, email address opt-in and/or collection, human operator flows, subscription-related features, security and/or verification features and/or other features provided to users and/or entities.

FIG. 5 is a flow diagram of an example process for providing users with content and/or advertising from a subscription network and/or entities across email and/or other channels.

FIGS. 6 and 6A are generally schematics and/or interfaces illustrating example opt-in features provided by subscription networks and/or entities to users.

FIG. 7 is an interface illustrating an example application for providing cross-channel and/or network and/or entity opt-in management, call-related settings, and/or other settings and/or preferences to users.

FIG. 8 is an interface illustrating an example application for providing content management, incentive and/or advertising management; settings and/or preferences; payment and/or billing management and/or other features to entities.

FIGS. 9 and 9A generally are schematics and device interfaces illustrating example content and/or advertising being generated and/or delivered to users across various channels and/or devices.

FIG. 10 is a flow diagram of an example process for providing users with device or browser cookies to enable adverting and/or content from a subscription network and/or entities across devices, apps and/or Internet browsers.

FIGS. 10A and 10B generally are device interfaces illustrating example advertising being triggered via cookies and displayed to users of devices and/or Internet browsers while using search engines or browsing other content.

### DETAILED DESCRIPTION

The following U.S. Provisional Patent Applications are hereby incorporated by reference as if fully set forth herein:
Application No. 61/667,032 filed Jul. 2, 2012, titled “METHODS AND SYSTEMS FOR PROVIDING PHONE CALL-BASED OPT-IN TO EMAIL COMMUNICATIONS”;
Application No. 61/693,840, filed Aug. 28, 2012, titled “METHODS AND SYSTEMS FOR PROVIDING PHONE CALL-BASED LINKING OF USER PROFILES ON SOCIAL NETWORKS”;
Application No. 61/735,821, filed Dec. 11, 2012, titled “METHODS AND SYSTEMS FOR PROVIDING APP-TO-PHONE CALL LINKS AND FEATURES TO APP USERS CALLING PHONE NUMBERS IN A NETWORK”; and
Application No. 61/765,761, filed Feb. 17, 2013, titled “PROVIDING CROSS-CHANNEL OPT-IN, MANAGEMENT AND ADVERTISING.”

The use of electronic communications, for example email, between business networks, businesses, organizations, agencies, representatives and/or individuals (“entities”) and their customers, prospects, audiences and/or other interested parties (“consumers” or “users”) has become widespread. One example way for consumers to receive incentives, discounts, offers, promotions, news and other information (“content”) from the entities they patronize is via subscriptions, memberships or other requests (“opt-ins”) to receive communications and/or content to consumers' email addresses, email accounts, text messages, social media profiles, mobile devices, applications, Internet browsers, home addresses, and/or various other devices and/or communication channels (“channels”).

For example, when consumers want to receive content, for example delivered via email, from various entities, they may first search for these entities on the Internet, for example using an Internet search engine. They may then find the websites or web pages of those entities and look for a way to “subscribe” or “opt-in” to receive communications from those entities, for example by using an online and/or website subscription form.

However, the existing methods used by consumers to find the appropriate entity websites, to find the locations of the opt-in subscription forms (if any) and then to opt-in to entity communications may be time-consuming and/or complex. For example, some of these web-based opt-in forms require a few steps or “clicks” to complete. Alternatively, others require many clicks and/or steps to complete the opt-in process.

In other examples, the location, design, format or form fields required by entities to opt-in to their communications may be varied and/or many. Each opt-in form may be different from the other. In addition, for example to prevent computerized robots from automatically filling out the forms, digital verification systems may be used within the opt-in forms, such as “CAPTCHA” verification systems. These verification systems may help to reduce automated form completions, but they may not benefit consumers and, instead, may create additional barriers for consumers to opt-in to communications from entities.

In further examples, with online or electronic opt-in forms, sometimes the same information is requested on each form from each different entity, such as the consumer's name, email address, phone number, etc. Consumers may repeat the process over and over, entering much of the same information on each form for each entity for which they want to opt-in. In other examples, the process may need to be repeated dozens of times across all of the entities for which consumers wish to receive communications.

Another example way by which consumers may opt-in to receive communications may be when they purchase something from entities. For example, during Internet-based purchase processes, sometimes at the end of the processes, consumers may be prompted to indicate whether or they would like to opt-in to receive communications from ecommerce entity. However, this process may only be effective with purchases made via an interactive checkout process, such as an online shopping cart or at a physical store location via a kiosk, handheld computer terminal or some other interactive user interface. These types of purchases are still only a small percentage of total consumer interactions with entities, especially for small and locally-based businesses where most purchases take place “offline.” The purchase-based opt-in also occurs at a time when the consumer may be already a customer of the entity and when offers and promotions for consumers who are not yet customers are less relevant.

In another example opt-in method, consumers may be asked to opt-in verbally by front desk persons or receptionists when visiting entity physical locations (such as offices or retail stores). In those cases, entities may collect and store collected consumer information in a computer-based system or some other non-computer, paper-based tracking system. Further, an entity with a physical store location may offer consumers a way to drop their business card or sweepstakes entry into a “fish bowl” or other physical, non-computerized collection method. Again, these methods may be cumbersome for both parties, are prone to errors during data entry or scanning, and take a long time period from the time consumers opt-in to the time consumers start getting communications from the entities. The non-computer, in-store method usually does not allow for offers or discounts to be delivered instantly or immediately before a purchase takes place.

When consumers want to immediately reach entities, one of the common methods used may be to contact the entities by finding or retrieving entity phone numbers and placing phone calls to the entities. This may be an example way to reach the entities to get information, schedule appointments, find out hours of operation, and/or receive other services and/or features from entities.

When consumer calls are placed to the entities, entity phone operators and/or persons receiving the calls may not ask callers if they would like to opt-in to receive communications, information or offers from the entities. In these examples, consumers may not be offered the opportunity to opt-in and they may not ask to opt-in without being prompted by entity representatives.

Alternatively, if entities ask consumers if they would like to opt-in for communications, the methods for obtaining and/or activating a subscription, for example email subscriptions, may be unreliable and/or cumbersome for entities and/or consumers. For example, using human operators and/or receptionists to manually write down consumer email addresses on paper and/or manually enter them into an unsophisticated system may be prone to errors and/or delays in starting the opt-in email subscriptions. In addition, manually obtaining opt-in via human operators may take too much time away from consumers and/or entities, reducing productivity for one or more of the parties.

Some of the above examples may only allow consumers to opt-in to one entity at a time. The steps may have to be repeated across each new and/or different entity and/or entity location for which consumers want to opt-in, causing, for example, extra and/or wasted time and/or steps.

While care has been taken to attempt to ensure that the foregoing discussion is an accurate description of conventional systems, any statements therein are not admissions that conventional systems actually operate in the manner described. Rather, the discussion is provided in an effort to provide a framework for understanding a context for the subject disclosure.

Aspects of the subject technology described herein attempt to address the aforementioned issues and/or opportunities. For example, consumers (“Users”) may be provided with ways to opt-in to data exchanges, content and/or communications (for example, email content and/or advertising) and/or to receive other services, features and/or benefits from entities (“Entities”) and/or networks of Entities (“Subscription Networks” or “SNs”) via email and/or one or more networks and/or channels and/or modes of delivery. With the subject technology, Users may be provided a variety of ways to opt-in to the SN(s) and/or Entities via various interfaces and/or methods and/or by providing one or more of their User phone numbers (“UPNs”) and/or by opting-in by placing one or more phone calls to one or more enabled Subscription Network Phone Numbers (“SNPNs”). Users who have enabled their phone service providers to share their names, phone numbers and/or other information (for example, via “Caller IDs” and/or UPNs) and/or who provide their phone numbers manually, may be invited, within phone calls and/or forms, to opt-in to one or more SNs and/or one or more Entities, for example via automated and/or semi-automated interactive voice response (“IVR”) systems which may include phone-tree menu-based systems. UPNs may serve as Users' “identifiers” and/or “unique identifiers” in opt-in databases and/or systems and/or in other ways, for example to identify Users and/or callers and/or to provide features and/or services.

Various systems may be used to collect Users' email addresses manually or digitally via speech-to-text (“STT”) transcription technologies and/or to verify and store the results. Online, offline, regular phone calls, bar code scans, in-person or other interfaces or other UPN and/or opt-in collection methods may also be used to solicit and/or collect Users' opt-in to the SNs and/or Entities and/or to link calls made from their UPNs to content and/or in-call features from the SN(s) or Entities. Collected User email addresses may be stored in SN and/or Entity databases as being “opted-in” to content and/or in-call features provided by one or more Entities and/or SNs. In one example of the present disclosure, during call sessions to SNPNs, after completing an opt-in or performing other tasks or using other features, Users may be transferred through to an Entity in a way similar to what would happen if the User called the Entity directly through one of its non-SNPN phone numbers.

In examples within the present disclosure description, Users may be provided applications (“User Apps”) and/or other ways to opt-in, to manage their opt-ins, to manage their email and/or digests and/or other content subscriptions, to manage other settings and features, to opt-in/out, to view their subscriptions and histories and other services and/or features and/or aspects. Users may be provided various incentives and/or content via various methods and/or channels at various intervals. Also within examples of the present disclosure description, Entities may be provided applications (“Entity Apps”) and/or other ways to participate in the SN, to add and/or manage User-delivered content, to advertise, to add or manage payments and payment methods, to link application service providers (“ASPs”) and/or to view their account settings and details, view reports of their advertising (such as impressions, clicks, User call rates, coupon success rates, etc.) and/or other services, features and/or aspects. Various other security, verification, call-related, opt-in and/or other aspects and/or features of the present disclosure are described.

In one aspect of the present disclosure, phone numbers (“Subscription Network Phone Numbers” or “SNPNs”) may be procured, hosted and/or provided and/or displayed and/or advertised and/or dialed by Users via, for example, Subscription Networks and/or via Entities and/or other parties and/or anywhere a phone number may be seen, displayed, dialed and/or used. When Users dial SNPNs, example IVR and Phone Tree Engines described further below and/or other software and/or systems hosting and/or running these SNPNs may perform various tasks, for example obtaining Users' phone information, and/or “Caller IDs”, which may include Users' names, Users' phone numbers (“UPNs”) and/or other information.

In another aspect of the present disclosure, when Users make telephone calls to SNPNs, they may be provided with and/or interface with a hosted and/or automated and/or semi-automated interactive voice response (“IVR”) and/or phone tree and/or human-assisted telephone system. “IVR and Phone Tree” systems may be used in a variety of ways, for example to identify Users, either by their UPNs obtained via Caller IDs and/or by collecting Users' email addresses via speech-to-text transcription technologies and/or methods further described below. Example IVR and Phone Tree systems may also be used to provide other various features and/or tasks, for example providing Users with information, providing phone tree and/or menu options, collecting and/or recording user voice and/or keypad inputs, accessing various databases, providing call-related features, facilitating human operator assistance and/or transferring User calls to other destination phone numbers and/or various other features and/or functions.

In yet another aspect of the present disclosure, User “opt-in” may be obtained and/or utilized. For example, IVRs and/or phone trees, voice recordings and/or text transcriptions may be utilized to obtain and/or verify User opt-ins and/or email address information. Other applications and/or other user interfaces and/or channels and/or modes may also be used to solicit and/or obtain User opt-in, either as a discreet process or within another process, for example within online registration forms and/or as part of a phone call sessions. In various examples of this aspect, Users may initiate, be aware of, manage, change, authorize and/or de-authorize their opt-ins and statuses and/or the sharing of their UPNs and/or email addresses and/or other contact and/or personal information. Features related to this aspect may be used, for example to identify Users during phone calls made to SNPNs; link Users and/profiles and/or history via, for example, Caller ID, email addresses and/or call information; create and/or distribute content notifications, messages and/or other displays of content; exchange information related to their phone calls to SNPNs and/or other opt-in preferences and/or settings. Also with this aspect, SNs and/or Entities may present and/or recommend additional SNs, SNPNs and/or Entities to which Users may want to opt-in. Additionally, examples may include methods and systems for Users to “opt-out” of and/or “block” various SNs, Entities, SNPNs, etc.

In another aspect of the present disclosure, User phone numbers (“UPNs”) may serve as “identifiers” and/or “unique identifiers” which may be stored, accessed and/or used in a variety of ways. For example, UPNs may be stored in association with the various User opt-ins and User opt-in preferences and/or settings. In other examples, UPNs may be linked to User profiles and User accounts so that various systems and/or features and/or functions of the subject technology may be accessed and/or activated and/or provided to one or more Users and/or Entities and/or SNs.

In a further aspect of the present disclosure, various systems and processes as part of the subject technology, for example the “Opt-in Engine” and/or other systems and processes, may examine various transcribed email address results from one or more User voice recordings and/or may compare results with an email address resource database and/or may assign confidence levels to determine the likelihood of having obtained a valid User email address. In one example, when two or more User voice recordings are made and the User's email addresses are transcribed from those recordings and are found to be identical or very close matches to each other and/or have known and/or identifiable variations from each other, the resulting email address obtained is likely to be correct and it may be verified and/or confirmed and/or stored as opted-in. If the results do not exactly match, for example, but vary by a known or minor variant, the “Opt-In Engine” and/or other systems may be able to determine the correct email address with a high enough “confidence score” to accept it. When there is a high confidence that a good email address has been obtained, Users may be opted-in at those email addresses. When no methods produce high enough confidence score for a good User email addresses to be confirmed, in some examples, human-assisted verifications may be used to produce verified User email address matches and/or opt-ins.

In another aspect of the present disclosure, Users may call specific types of “Dial-Through” SNPNs which may, after various call session processes, messages and/or other IVR and/or Phone Tree processes and/or other tasks are completed, transfer Users to one or more SNs, Entities and/or other parties at destination phone numbers. For example, if Users want to call Entities to reach people answering phones at the Entities' destination phone numbers, a “Dial-Through” SNPN may be provided and/or displayed to Users and then dialed by Users. In these example, within those call sessions, Users may be provided various services and/or features, for example via an IVR and/or phone tree. At the conclusion of various call session features, Users may then be transferred to Entities, SNs and/or other parties. Alternatively, Users may choose to skip the call session features altogether and just be transferred through to the SNs, Entities and/or other destination phone numbers through a “dial-through” engine and/or process. In this aspect, with “Dial-Through” SNPN's, opt-in likelihood and frequency may be increased for the SN and/or Entities as the opt-in may be solicited and/or make take place in the course of the regular phone calls made by Users to the Entities and destination phones to which they call.

Alternatively, in another aspect of the present disclosure, SN and/or Entity opt-in may be obtained when Users call specific types of “Subscribe” SNPNs which are designed to make it even faster and/or easier for Users to opt-in. The “Subscribe” SNPNs may be specifically used and/or advertised and/or promoted by SNs and/or Entities as easy ways for consumers to opt-in to receive content from these networks and entities. For example, the IVR and phone tree systems utilized with these “Subscribe” SNPNs may not transfer calling Users to other destination phone numbers at the conclusion of the calls, but may primarily serve as quick ways for Users to opt-in.

In another aspect of the present disclosure, one or more User applications and interfaces (“User Apps”) are provided whereby Users may initiate, manage, change and/or cancel their opt-ins, settings, preferences and/or content. For example, Users may be able to manage their linked data, the Entities to which they are opted-in, the content they receive, their call history, recommendations, special offers and incentives, content delivery frequency and/or timing, channels for delivering content, the sharing or blocking of their personal data and/or other settings, options and/or features.

In another aspect of the present disclosure, User Apps provide Users with ways to set and manage what types and/or pieces of information, if any, including but not limited to their names and UPNs, are shared with Entities. For example, when Users call a “Dial-Through” SNPN to reach an Entity, this aspect within the subject technology may allow those Users to determine whether or not their Caller ID information and/or other personal information may be passed on to the destination Entity during those SNPN call sessions. Users may also block Entities and/or groups of Entities from receiving various pieces and/or types of information.

In another aspect of the present disclosure, one or more UPNs and/or Users may be opted-in to one or more SNPNs and/or Entities within one or more SNs. SNs may be authorized by Users to use and/or exchange information related to their calls, email addresses and/other information. For example, once Users are opted-in to SNs and their phone numbers (“UPNs”) are identified and/or are entered by Users, they may not need to again provide their contact information, for example email addresses, in order to opt-in to SNPNs and/or one or more Entities which are part of those SNs. For example, when Users who are opted-in to a SN make phone calls to SNPNs assigned to member Entities, those Users may be able to easily opt-in to those member Entities, such as by placing phone calls to those Entities' “Subscribe” SNPNs and/or by speaking or pressing menu options during “dial-through” SNPN call sessions. With this aspect, once the UPNs and/or Users are opted-in to the SNs, the subject technology makes it easy, for example, for Entities to solicit and/or receive opt-in to their content and/or for Users to utilize their UPNs and/or other methods to opt-in to receive valuable offers, information, services and/or content from various SNs and/or Entities.

In yet another aspect of the present disclosure, Entities and/or their agencies may elect to actively participate as members of the SN and/or they may be provided with ways to advertise to Users through various channels utilized by the SN. For example, with the subject technology, Entities may be provided one or more SNPNs to use in their communications or advertising. Entities may also be provided applications (“Entity Apps”) and/or other interfaces where they may, for example provide content (for example, incentives, offers, advertising and/or news) to the SN to be communicated to Users; pay for advertising and/or enter credit card and/or other payment information; manage and/or receive content and/or settings through interactive interfaces; view their account settings and details; view reporting, for example related to their advertising (such as impressions, clicks, User call rates, coupon success rates, etc.); and/or they may utilize additional services and/or features.

In another aspect of the present disclosure, SNs and/or Entities and/or their agencies or other representatives may be provided with various ways to deliver content to opted-in Users via email and/or other platforms, channels and/or methods. In one example way, Entities may connect their application service providers (“ASPs”) to the SN systems so that Users, User email addresses, opt-in, opt-out statuses, and/or other User and/or content and/or email information may be added, removed, exchanged and/or updated between Entity ASPs and the systems of the SN and/or of the subject technology. Alternatively, in other examples, where Entities may manage their own User databases and/or applications in-house (vs. using ASPs), the subject technology provides ways to link those Entity databases, applications and/or systems. ASPs may include any type or manner of technology providers, service providers, application programming interface (“API”) providers, agencies, entity delegates and/or other entities whose users may interface with the disclosed technology.

With another aspect of the present disclosure, SNs may assign, on their own and/or without participation from Entities, SNPNs to Entities and/or promote and/or advertise and/or list those SNPNs for use by Users. Entities may not need to explicitly and/or actively participate and/or be members of the SNs. For example, this may be the case with a directory of Entities whereby SNPNs are assigned to each Entity within directory that may be provided and/or displayed to Users, whether or not Entities participate and/or pay any advertising fees for SNs' services and/or features. For example, SNs may provide Users with content and/or offers related to the Entities they have called and/or calls made using other and/or related SNPNs, whether or not these Entities expressly participate in the SNs.

In another aspect of the present disclosure, via example “invitation engines,” opt-in invitation messages displayed and/or played to calling Users may be automated, customized, tested and/or provided as voice or text-to-speech (“TTS”) so that SNs and/or or Entities may provide and/or test various opt-in incentives, for example an instant discount or coupon provided by SNs and/or Entities, to Users to encourage Users to opt-in.

In another aspect of the present disclosure, once Users establish opt-in with Entities and/or SNs, voice and/or email and/or text message confirmations may be delivered to these Users, for example, along with interfaces, providing Users with easy ways to manage their opt-in settings and to opt-in or opt-out of any particular Entity and/or SN.

In yet another aspect of the present disclosure, various authentication, verification and/or security measures may be utilized. For example, when Users opt-in, verification emails may be sent to the email addresses provided or obtained for those Users before their email addresses are accepted and/or used. With these examples, Users may be required to click on hyperlinks within the verification emails before those Users are able to utilize and/or access various features within the subject technology. In another example, systems in the subject technology may send text messages and/or automated or human call-backs to the Users' UPNs to verify the UPNs and/or to verify the identity of Users and/or complete various opt-in processes. In another example, Users may provide and/or be assigned personal identification numbers (“PINs”) which may be required in various places with the processes of the subject technology, for example during calls to SNPNs where it may be important to verify UPNs and/or the identity of Users, for example when accessing personal information and/or when personalized and/or financial services or features are provided.

In yet another aspect of the present disclosure, triggered and/or regularly scheduled content, for example notices and/or “digests,” may be provided and/or delivered to Users. For example, this content may include, but is not limited to, incentives, offers, coupons, discounts, social media links, news, recommendations, opt-in suggestions, opt-in status and/or other content. With the subject technology, Users may be provided content related to the Entities to which they have opted-in and/or Entities to which they have called (for example, “Here are great offers from the places you have called”) and/or recommendations, for example based on User's call history and/or Users' call patterns and/or calls made by other or similar Users. This variety of content may be delivered by the subject technology via email, text messages, applications and/or other methods and/or channels. The content may be triggered by certain events (for example, when a User calls a SNPN) and/or at a specific or regular intervals (for example, a regular “Digest” email that be delivered at a certain time each day or week, etc.) and/or on a non-regular and/or “live” basis (such as within User Apps).

In another aspect of the present disclosure, various call-session and/or call-related features and/or services may be provided to Users who call various SNPNs. For example, during calls placed to SNPNs, the various systems and/or applications used by SNs and/or Entities and/or their human operators may access information related to calling Users, such as their contact information, call history, transaction histories and/or other information. User and/or history and/or profile information may be utilized to provide, for example, more personalized and/or improved and/or more automated features and/or services to calling Users.

In the drawings and/or descriptions in this application, elements and/or components shown as separate may be combined and/or single elements may be broken apart into different elements. Also, it may be possible that, where only one or finite numbers of example elements(s) is/are shown, many and/or duplicate and/or versioned elements may be possible in various examples. For example, though one “IVR and Phone Tree Engine” may be shown and/or described, duplicate, redundant, back-up, versioned and/or any other number and/or type of “IVR and Phone Tree Engines” may be included. In addition, components in a described system and/or flow and/or environment may communicate and/or interact with other components in a different way, scope and/or order than as described herein, including simultaneously.

Furthermore, one or more components may be real and/or physical and/or virtual. Data storage, computer processing and other computer functions and processes may be completed solely on one computer or server or virtual component or performed or stored across more than one component. It should be noted, however, that when the subject technology is implement as a system, at least one component of that system is or should be interpreted as including a tangible physical device. For example, even when the technology is implemented as a system using virtual computing devices, those virtual computing devices ultimately run on tangible computing elements (e.g., servers, physical storage devices, physical interfaces, and the like), and the system should be interpreted as incorporating those tangible computing elements. These tangible computing elements may be run by third parties different from the entities participating in the subscription network and/or their application service providers. This restriction may or may not apply to instances where the subject technology is implemented as a process.

Various elements and/or components, such as telephones (POTS/PSTN, wireless, app-based, etc.) and/or computing devices (servers, computers, tablets, phone devices, virtual, cloud-based, etc.) and/or networks (Internet, WANs, LANs, etc.) and/or databases (disks, disk arrays, virtual, cloud-based, etc.) shown and/or described in this application are merely examples and may include elements and/or components not specifically identified and/or not yet available and/or which may perform similar functions and/or provide similar services to those shown. Methods and/or systems and/or flows and/or environments and/or processes described may be include, at any time, users and/or entities and/or networks and/or groups, singular and/or a plurality, whether large or small, in serial order, parallel order and/or simultaneously.

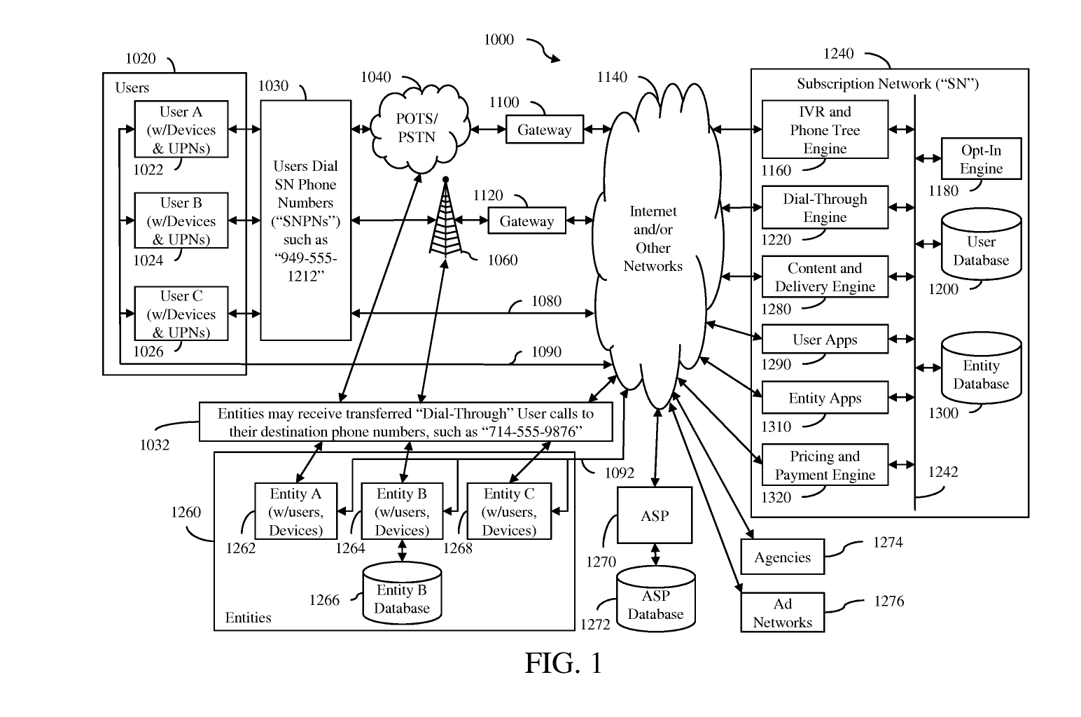

Turning to FIG. 1, a high-level block diagram is shown including an example environment and system with example components and groups of components; for example a subscription network and its components, users and user groups, entities and entity groups, computing devices, databases, software, networks, flows, connections and other systems and components; and is described in the present disclosure.

Briefly, aspects of FIG. 1 illustrate an opt-in system including, among other elements, a subscription network including at least tangible computing elements, one or more interfaces for users to access the subscription network and to provide information for receipt by at least one of a plurality of entities that interact with or operate the subscription network, and one or more interfaces between the subscription network and the plurality of entities that interact with or operate the subscription network to communicate with users. The information received by a first entity that interacts with or operates the subscription network is used to deliver a communication, information or offer to at least one of the users from a second entity that interacts with or operates the subscription network, with the first entity different from the second entity.

In some aspects, the one or more interfaces for the users permit a user to opt-in to receive the communication, information or offer from the second entity. The communication, information, or offer delivered to the at least one of the users who opt-in may include for example a phone number. The one or more interfaces for the users may be provided over the Internet, a computer network other than the Internet, or over a telephone device. In a case that the interfaces are provided over a telephone device, the one or more interfaces for the users to access the subscription network may include an interface that transfers the at least one of the users to a destination phone number. Furthermore, when a telephone device is used, a user may provide the information for receipt by the at least one of a plurality of entities that interact with or operate the subscription network by making a telephone call, and the provided information may include an identified phone number from which the user calls.

In other aspects, the one or more interfaces between the subscription network and the plurality of entities that interact with or operate the subscription network may be provided over the Internet or a computer network other than the Internet. The communication, information or offer may be delivered to the user in a separate communication from a communication in which that one of the users accessed the subscription network.

The system may include additional elements, for example a database of information provided by the users. The database may include at least the information received by the first entity that interacts with or operates the subscription network and may be used to deliver the communication, information or offer from the second entity that interacts with or operates the subscription network. The database may be accessed by the first entity, the second entity, or both through one or more application service providers different from the plurality of entities that interact with or operate the subscription network. The one or more interfaces for the users may permit at least some of the users to modify those users' information in the database. For another example, the system may include a database of communications, information, or offers from which the communication, information or offer delivered to the at least one of the users is derived.

The terms “interact with” and “interacts with” may broadly include direct interactions, indirect interactions through one or more intermediaries, or both. For example, the various interfaces discussed in the foregoing paragraphs may be provided by or through the first entity, the second entity, one or more subscription network operators, one or more application service providers, one or more advertising services, one or more advertising networks, or some combination thereof. The first and second entities may be businesses to which the communications, information or offers apply or those who provide services to such business, including but not limited to the examples of those by or through which the interfaces may be provided. In addition, the terms “communication, information or offer” and “communications, information or offers” broadly describe any combination thereof and may include content, interfaces, access information for interfaces (e.g., phone numbers, web addresses, or the like), features, advertisements, cookies, offers, inquiries, data, and any other type of information that may be communicated to a user. The subject technology may be used and/or facilitated by different entities than those discussed above, and the subject technology is not limited to the foregoing briefly described aspects.

In more detail, the example environment and/or system 1000 of FIG. 1 shows an example set of Users 1020, for example User A 1022, User B 1024, User C 1026, etc. where they may be collectively be referred to as “Users 1020” and whereby any number of Users 1020 may interface with and/or access and/or utilize the system 1000.

Further, the diagram shows an example set of Entities 1260, such as Entity A 1262, Entity B 1264, Entity C 1268, etc. where they may be collectively be referred to as “Entities 1260.” Each of their respective User 1020 and Entity 1260 blocks in the diagram may also encompass each of their corresponding attributes, computing devices (“Devices”), Entity employees and/or users, applications (“Apps”), phone devices (“Phones”), networks and network environments (“Networks”), email addresses, email applications, email accounts, web browsers and/or their corresponding User Phone Numbers (“UPNs”) and/or Entity phone numbers and/or Entity databases and/or ASPs and/or other corresponding attributes.

Example Users 1020 and/or their respective Devices and/or Apps and example Entities 1260 and/or their respective Devices and/or Apps are also shown connected to the Internet and Other Networks, as well as any networked apps, email, etc., by connections marked as items 1090 and 1092. Although only three example Users 1020, three example Entities 1260 (and their corresponding databases and/or ASPs), one example SN 1240 and one example Network 1140 are shown, there may be any number of each of these and/or other elements, in any combination and/or configuration and/or connections and/or displayed order. This example system 1000 provides Users 1020, Entities 1260 and/or Subscription Networks (“SNs”) 1240 with an environment for providing and/or performing operations and/or services including, but not limited to receiving and/or handling User 1020 phone calls and/or other data communications and/or transferring those calls to Entities 1260; providing User 1020 opt-in capabilities; providing User Apps 1290 and/or Entity Apps 1310; providing the collection and/or assembly of content; providing distribution of content; storing and/or managing data and/or network connections and/or data exchanges; and other services and/or features and/or functions. The system 1000, its networks, its sub-systems and/or its components may interface with many different systems, sub-systems, networks and/or components in any manner and/or order, including simultaneously.

Continuing to look at example system 1000 in FIG. 1, Users 1020 may place telephone calls by dialing Subscription Network Phone Numbers (“SNPNs”) 1030. SNPNs 1030 may be procured and configured by the SN 1240 and/or Entities 1260, in order to, for example, connect calls made to SNPNs 1030 with the services provided through the example system 1000 and/or the SN 1240. With just a few examples shown in the example system 1000, User 1020 phone calls may be received into the system 1000 through any manner of analog and/or digital telephones through services such as: plain old telephone services (“POTS”) and/or Public Switched Telephone Networks (“PSTNs”) 1040 as shown with User A 1022; wireless phone carriers and networks 1060 as shown with User B 1024; and/or digital computing devices and/or Apps, for example through voice over Internet protocol (“VOIP”), as shown with User C 1026 and his/her corresponding the connection(s) 1080 to the Internet and/or Other Networks 1140. These example Users 1020 and their telephone calls may be routed through various network gateways, such as with the ones shown with example Gateway A 1100 and example Gateway B 1120, and/or routed through the Internet and/or Other Networks 1140.

Continuing with example system 1000 in FIG. 1, Subscription Networks (“SNs”) 1240 may be made up of and/or interface with a plurality of Entities 1260 and/or their application service providers (“ASPs”) including, for example, across a variety of Entity 1260 types, sizes, industries, entities, products and services. SNs 1240 and/or Entities 1260 may include one or more entities and/or groups of entities, for example businesses, directories, organizations, websites, networks, individuals and/or providers of any other and/or types of products and/or services. Entities 1260 may consist of one or more SN 1240 members or non-members across a variety of individuals, businesses, websites, groups, networks and/or organizations. As mentioned previously, Entities 1260 may or may not be explicit “members” of SNs 1240 and/or may be connected to the SN 1240 via their respective SNPNs 1030. Each Entity 1260 may have one or more SNPN 1030 associated with its Entity 1260 and/or various physical or virtual Entity 1260 locations and/or subsidiaries and/or divisions. In the example system 1000, Entities 1260 and their respective destination phone numbers 1032 and/or employees and/or users and/or devices and/or telephones may be the receivers of transferred or “dial-through” telephone calls made by Users 1020. It may be possible to have examples of the system 1000 in which Entities 1260 are also the owners of SNs 1240, or vice versa, and/or where an Entity 1260 may be the sole Entity 1260 in the system 1000. Entities 1260 and/or providers of the SNs 1240 and/or SNPNs 1030 may all be the same companies, individuals or organizations, or a plurality of different combinations of ownership of the various parts by a plurality of individuals, companies and organizations. In just one example, the SN 1240 could be provided by a local restaurant directory company. Hundreds of restaurant Entities 1260 may be listed, each with different SNPNs 1030, with any combination of Entities 1260 which are explicit members and/or non-members.

With the example system 1000, Users 1020 may see and dial SNPNs 1030 which have been distributed and/or displayed in any manner by any method and/or channel, in some cases by SNs 1240, Entities 1260 and/or other channels or means. For example, SNPNs 1030 may be displayed to Users 1020 within any number or combinations of Device Apps, on business cards, websites, social media profile pages, in-person displays, within online and/or offline directories, online and/or offline advertisements, yellow pages, flyers or direct mail, or any other location, channel and/or method(s) where SNPNs 1030 may be displayed and called by Users 1020.

Each SNPN 1030 or combinations of SNPNs 1030 may be associated with various Entities 1260. SNPNs 1030 may be employed by the SNs 1024, for example, to obtain User 1020 opt-in to one or more Entities 1260 and/or SNs 1024. In another example, SNPNs 1020 may also be used to trigger content from either Entities 1260 and/or SNs 1024. For example, in some cases Users 1020 may provide information sufficient to opt-in to an offer or offers merely by calling an SNPN 1030. The identified phone number (e.g., determined by caller ID) from which the User calls may constitute sufficient information for the opt-in operations. Alternatively, the User might be requested to provide additional information, for example by using the phone's touchpad (e.g., “Press 1 . . . ”), via interactive voice recognition (IVR), or by speaking to a person on the call. SNPNs 1030 also can be used in other ways, for example for text message based communications.

The association of SNPNs 1030 to Entities 1260 may change, be re-assigned and/or be removed from the system 1000 at any time. For example, calling Joe Pizza using the assigned “949-555-1212” SNPN 1030 may generate content and/or offers sent to those Users 1020 calling that particular SNPN 1030. Likewise, Users 1020 calling a newly assigned Joe Pizza SNPN 1030, “949-555-8888,” may also receive similarly generated content and/or offers, as determined by SNs 1024 and/or in conjunction with Entities 1260. SNs 1024 may be the arbitrators and/or managers of which SNPNs 1030 are assigned and/or associated with which Entities 1260. SNs 1024 may also manage which content and/or offers are generated and to which Users 1020 that content may also be delivered, in conjunction with and/or at the direction of Entities 1260.

Continuing with FIG. 1 and example system 1000, Subscription Networks (“SNs”) 1240 may consist of a variety of components, for example servers, computers, networks, storage, databases and/or sub-systems, some examples of which are shown and described below. For example, components of the SN 1240 may include an IVR and Phone Tree Engine 1160, an Opt-In Engine 1180, a Dial-Through Engine 1220, a Content and Delivery Engine 1280, User Apps 1290 and/or User Database(s) 1200, Entity Apps 1310 and/or Entity Database(s) 1300, a Pricing and Payment Engine 1320 and/or networks 1242 which may connect each component to each other and/or to networks and/or to any number of components and/or combinations of components and/or to internal networks and/or to the Internet and/or other Network(s) 1140. Components in the system 1000 and/or the SNs 1240 may connect directly to internal networks (i.e. 1242) and/or to external networks (i.e. 1140) through a variety of interfaces represented in FIG. 1 by connecting lines to and from the various elements, and/or groups of components may share these and/or other interfaces.

Connecting lines illustrated and described herein, such as the connecting network lines marked as items 1090, 1092 and 1242, may represent one or more various networks or connections which are single-directional and/or multi-directional and/or have a variety of networking architectures and/or network components, hosted by one or more service providers in one or more location. For example, the network connections represented by items 1090 and 1092 may represent multiple and/or separate connections between individual Users or Entity users and their respective connections to the Internet or similar other networks, across a variety of their respective Internet Service Providers (“ISPs”) and/or various other network providers, networking architectures and/or connections.

In some aspects, the connecting lines represent interfaces that can permit Users and Entities, either directly or through ASPs or other channels, to interact with the SN 1240. Some or all of the interfaces depicted in FIG. 1 may be provided. Alternatively, entirely different interfaces may be provided either in addition to or instead of the depicted interfaces.

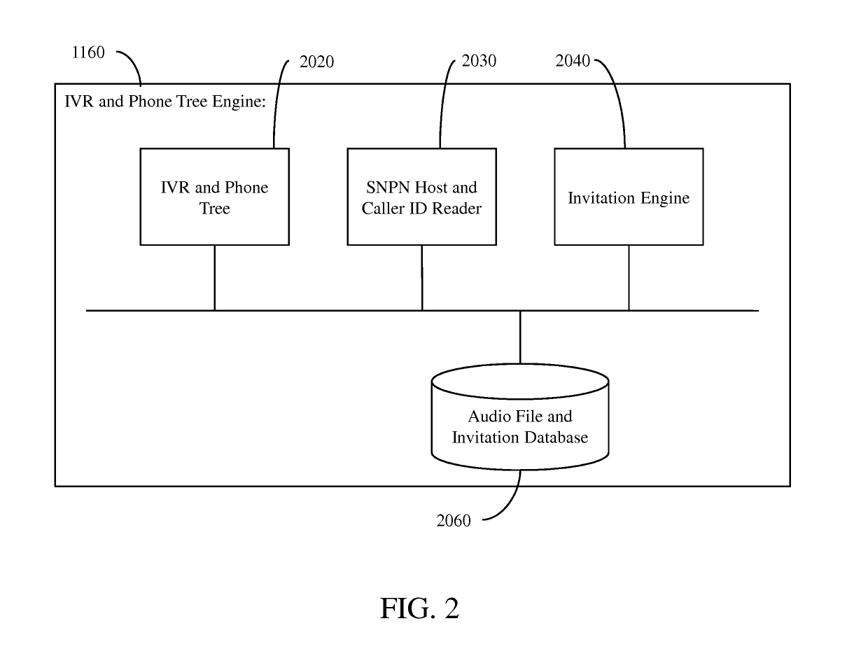

Within the example system 1000 and SN 1240, an example IVR and Phone Tree 1160 sub-system, further described in FIG. 2, provides services and functions including, but not limited to: procuring and hosting SNPNs 1030; receiving and managing telephone calls placed to SNPNs 1030; receiving, reading, storing and/or transmitting Caller ID and other User 1020 information, including UPNs, and/or other data related to calls placed by Users 1020; and/or performing many other services and features. Telephone numbers used in conjunction with SNPNs 1030 may be procured, configured and/or managed and/or data from calls made to them may be accessed by an IVR and Phone Tree Engine 1160. IVR and Phone Tree Engines 1160 may include, for example 3^{rd} party real, virtual and/or cloud systems not detailed in this application, but presently and commonly available through telephone carriers, call-tracking number providers, phone number application interfaces (“APIs”) and/or any number of providers of phone numbers, call tracking phone numbers and phone number technologies. Telephone numbers used in conjunction with SNPNs 1030 may be configured and programmed to be connected to an IVR and Phone Tree Engine 1160 to provide various functions, for example reading and transmitting Caller ID information and/or handling call-transfers and/or other functions. Caller ID information used in the example system 1000 may consist of the Users' 1020 Phone Numbers (“UPNs”), but may also include data such as like Users' 1020 first and last names, business names, or other information about Users 102, their UPNs or about their phone call sessions and/or session or other history (for example, duration of the calls, etc.). Examples of IVR and Phone Tree Engines 1160 may also use interactive voice response (“IVR”) systems and phone trees and/or menus during User 1020 phone calls, for example, inviting Users 1020 to opt-in and/or providing information and/or prompting Users 1020 for information.

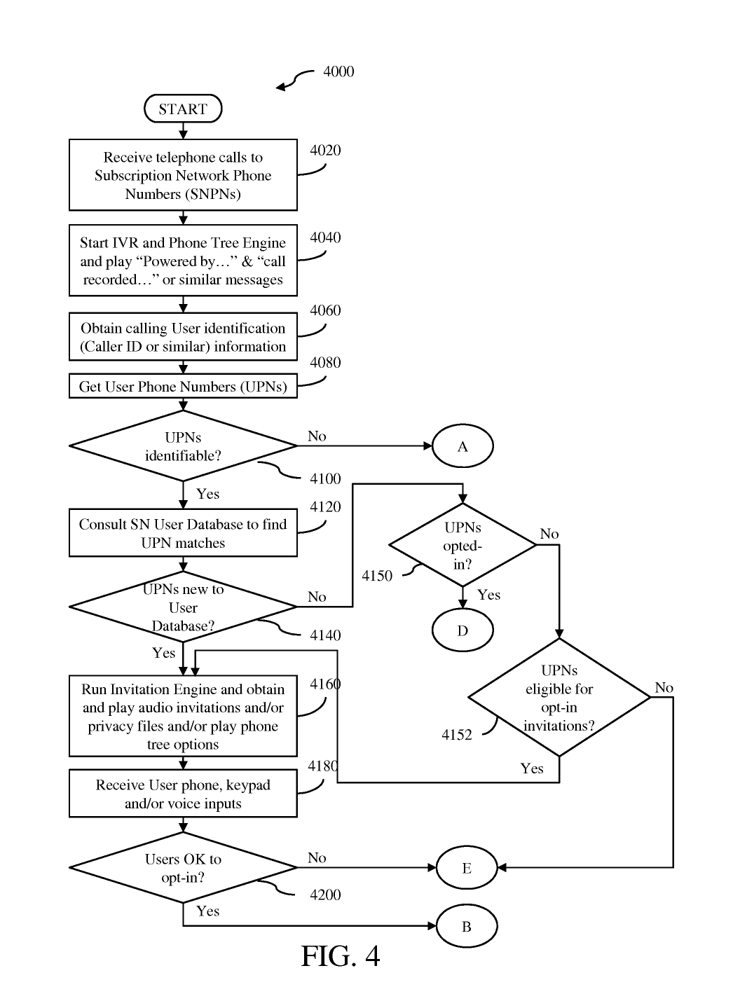

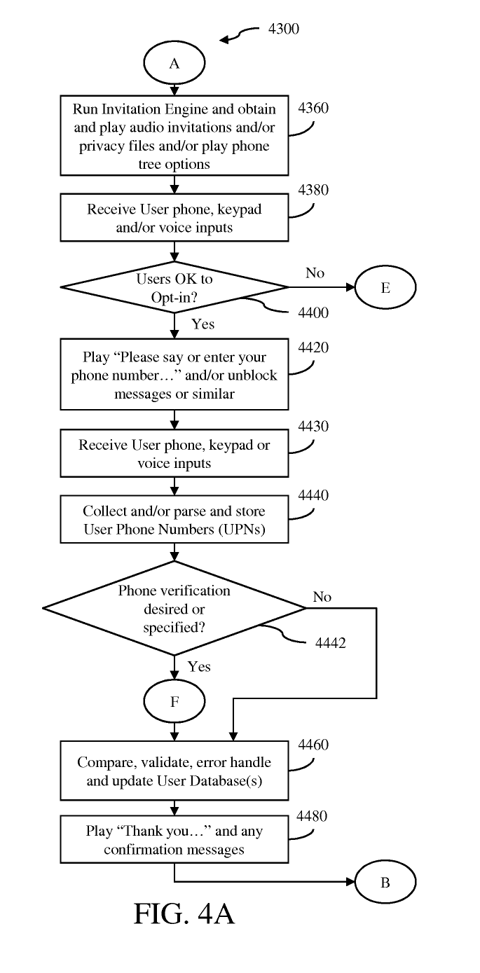

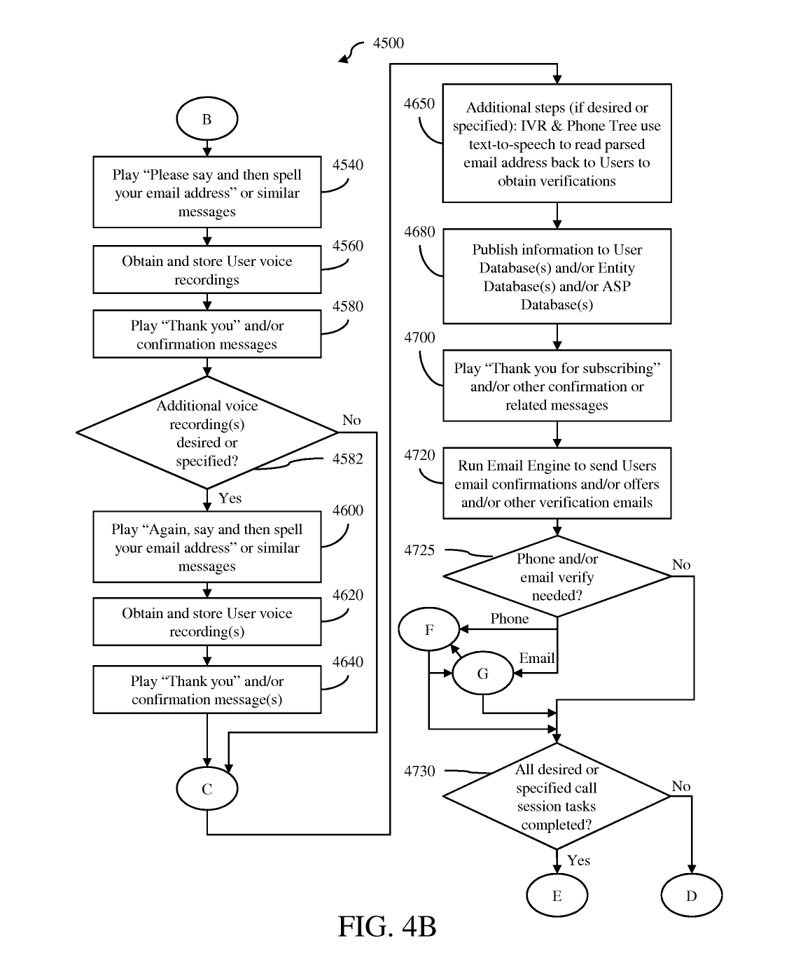

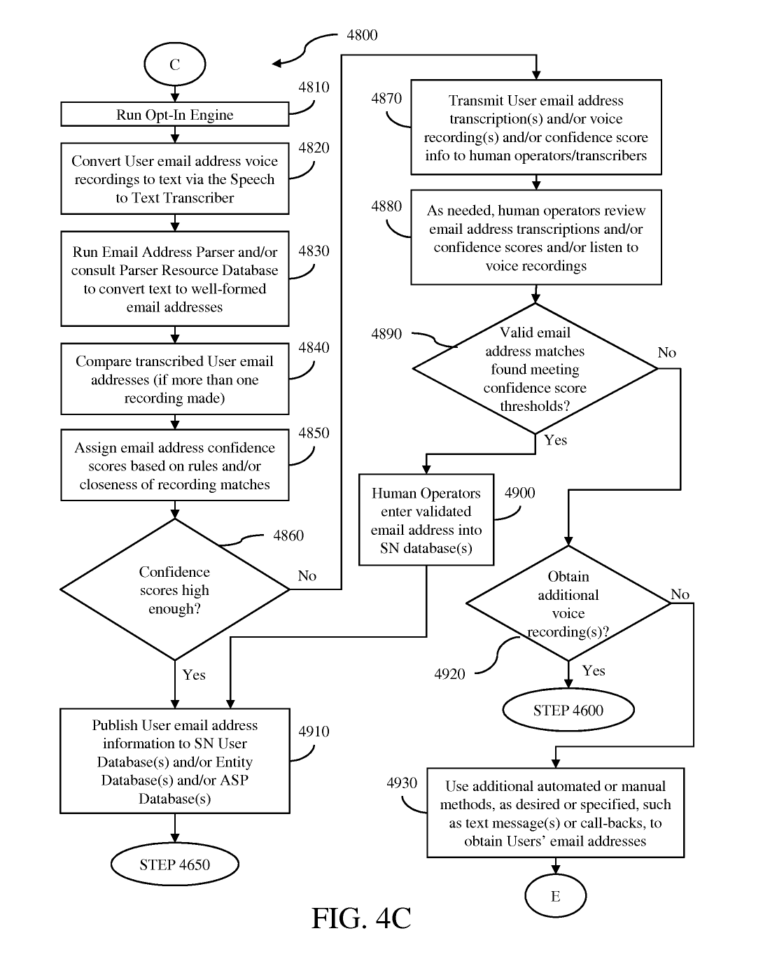

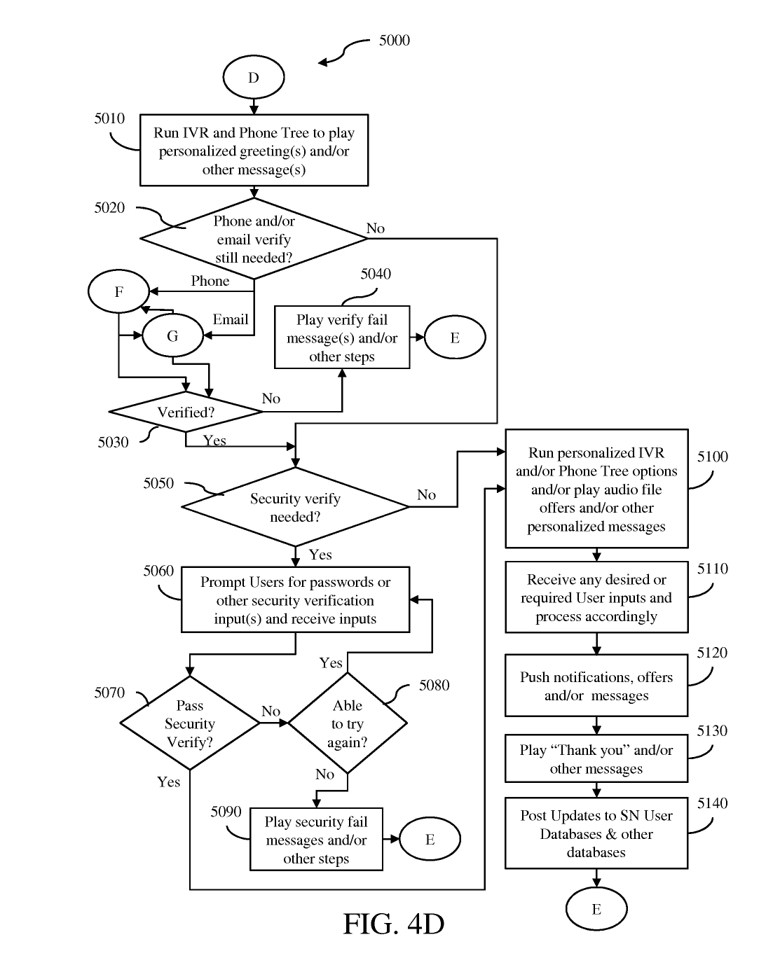

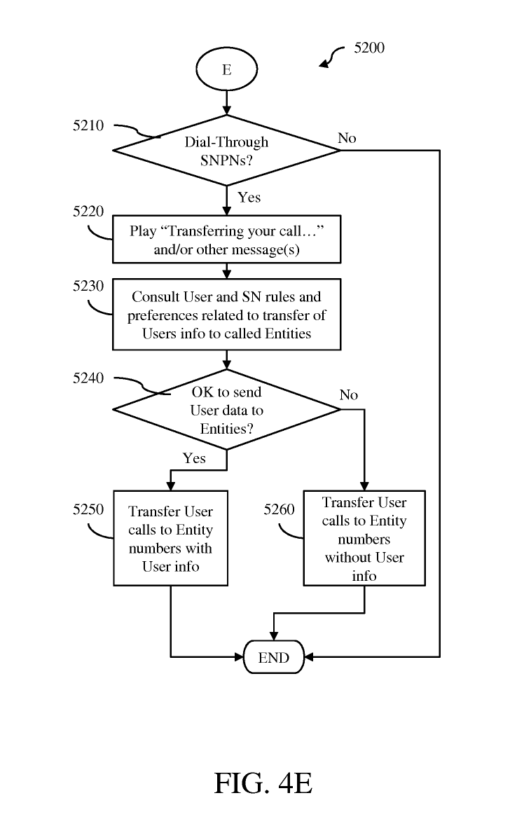

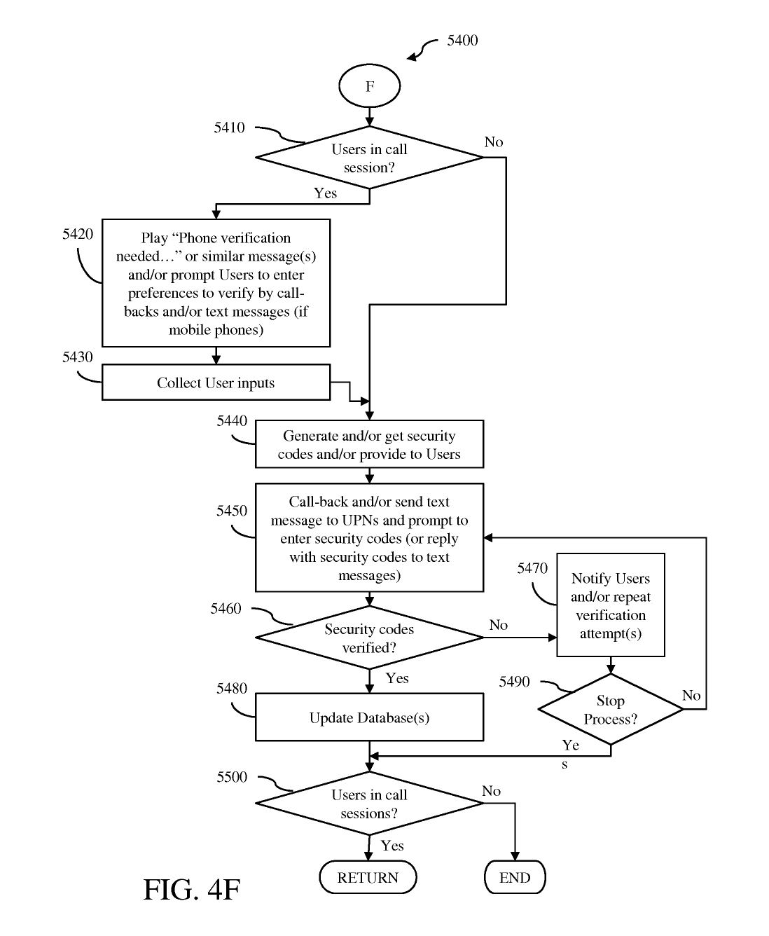

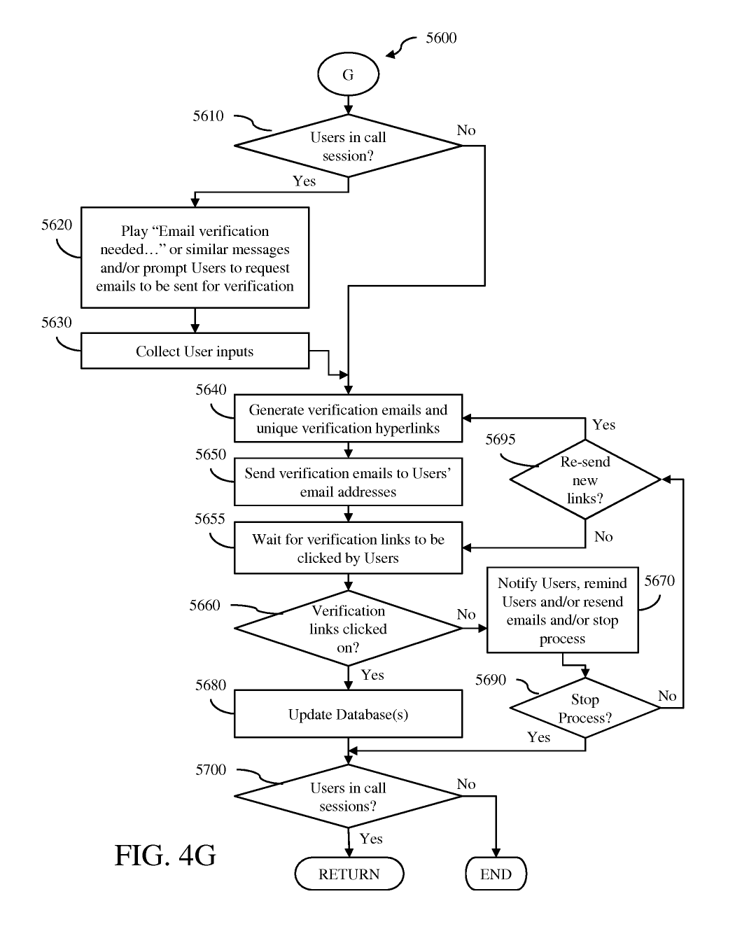

Upon receiving User 1020 phone calls to SNPNs 1030, an IVR and Phone Tree Engine 1160 may be activated and it may employ digital text-to-speech (“TTS”), recorded audio and/or integrated/live telephone operator assistance to provide information, instructions and/or other guidance to calling Users 1020 during their SNPN 1030 call sessions. An IVR and Phone Tree Engine 1160 may also collect information from Users 1020, present various phone tree menu options, and/or interact with and/or exchange information with the various other component sub-systems and/or parts of the SN 1240 and/or system 1000. An IVR and Phone Tree Engine 1160 may also be used within the example system 1000 to match the Caller IDs/UPNs, of calling Users 1020 to information stored in a User Database 1200. Using these matches and/or other processes described in more detail below, an IVR and Phone Tree Engine 1160 system may activate content creation and/or content distribution via the Content and Delivery Engine 1280 and/or other component systems. An IVR and Phone Tree Engine 1160 also may transfer User 1020 “dial-through” phone calls, for example to various Entity 1260 destination phone numbers 1032, via a Dial-Through Engine 1220. An example flow utilizing, among other components, an IVR and Phone Tree Engine 1160 is described below, starting with FIG. 4, process 4000.

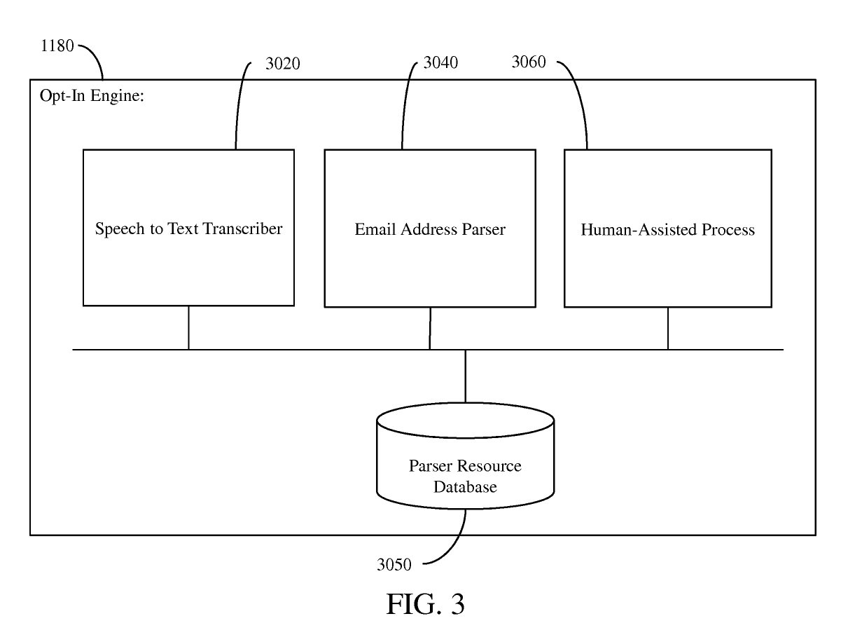

Continuing with FIG. 1, for Users 1020 who may not be identified within the SN 1240, as determined, for example, via the User Database 1200, as existing and/or opted-in Users 1020 and/or UPNs in the system 1000, an Opt-in Engine 1180 may be employed to collect User 1020 opt-in, preferences, email address information and/or other information and/or to link this information and/or settings to UPNs and/or User profiles. A more detailed diagram of the sub-components of an Opt-in Engine 1180 is illustrated in FIG. 3 and is further described below. A User Database 1200 may store information related to Users 1020 and/or other information. For example, Users' corresponding UPNs, opt-in statuses and/or preferences, call session history and/or related call information, email addresses, first and last names, Entity 1260 and SN 1240 preferences, email and content preferences, notification preferences, offers and/or other content and/or other information.

Continuing with FIG. 1 and system 1000, in example scenarios, “dial-through” phone call sessions may conclude via a Dial-Through Engine 1220 whereby it may be used to, for example, connect Users 1020 to the Entities 1260 and corresponding destination phone numbers 1032 they are intending to reach. Among many features and functions, some of which are described herein, a Dial-Through Engine 1220 may transfer these “dial-through” calls to designated Entities 1260 and their corresponding destination phone numbers 1032 which may connect to the Entities 1260 and their employees and/or users and/or call centers via any manner of Phones including but not limited to: POTS/PSTN lines 1040, gateways 1100 and/or networks 1140, as shown in example Entity A 1262; wireless carriers 1060, gateways 1120 and/or networks 1140, as shown with example Entity B 1264, and/or VOIP and/or other Internet-based Phones, Devices and/or networks 1092 and/or 1140, as shown with example Entity C 1268, and/or any other Devices, software and/or networks which may deliver User 1020 telephone calls to Entities 1260. Alternatively, User 1020 calls made to “Subscribe” SNPNs 1030 may end when all of the required tasks and/or steps in the call session have been completed. With “Subscribe” calls, a Dial-Through Engine may not be employed and/or these calls may not be transferred to Entity 1260 destination phone numbers 1032.

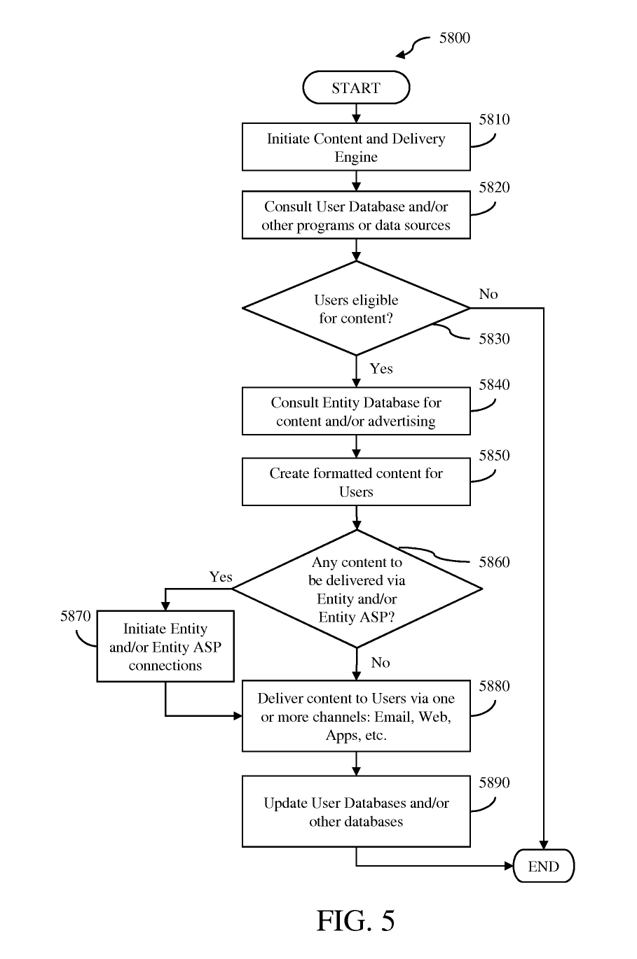

Continuing to look at FIG. 1, a Content and Delivery Engine 1280 interfaces with many of the components of the example system 1000 and may provide many features and functions, some of which are described herein. For example, content provided by Entities 1260 and/or stored in the Entity Database 1300 and/or content from other sources may be assembled, formatted and/or delivered by a Content and Delivery Engine 1280. A Content and Delivery Engine 1280 may also interface with User Database(s) 1200 to, among other functions, obtain data on User 1020 subscriptions, preferences, content format, content delivery schedules, offers and/or Entity opt-in preferences and/or more. A Content and Delivery Engine 1280 may create and deliver a variety of content across a variety of channels, platforms, devices and/or interfaces, for example email, at scheduled, triggered or any other intervals and frequencies, including daily digests and/or triggered and/or real-time. Some examples of content delivered via a Content and Delivery Engine 1280 are further illustrated in FIGS. 5A and 5B.

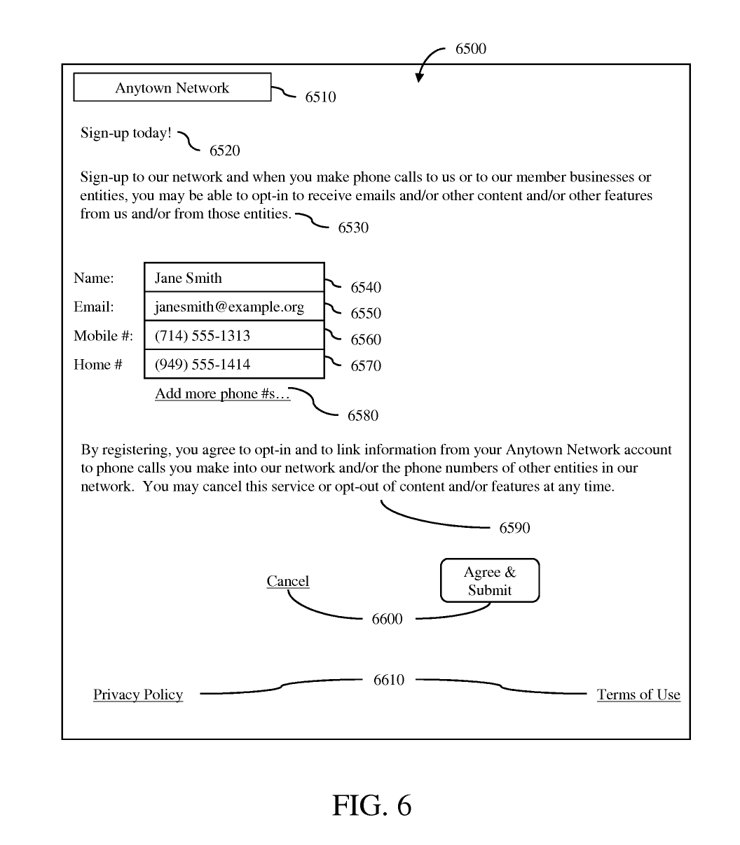

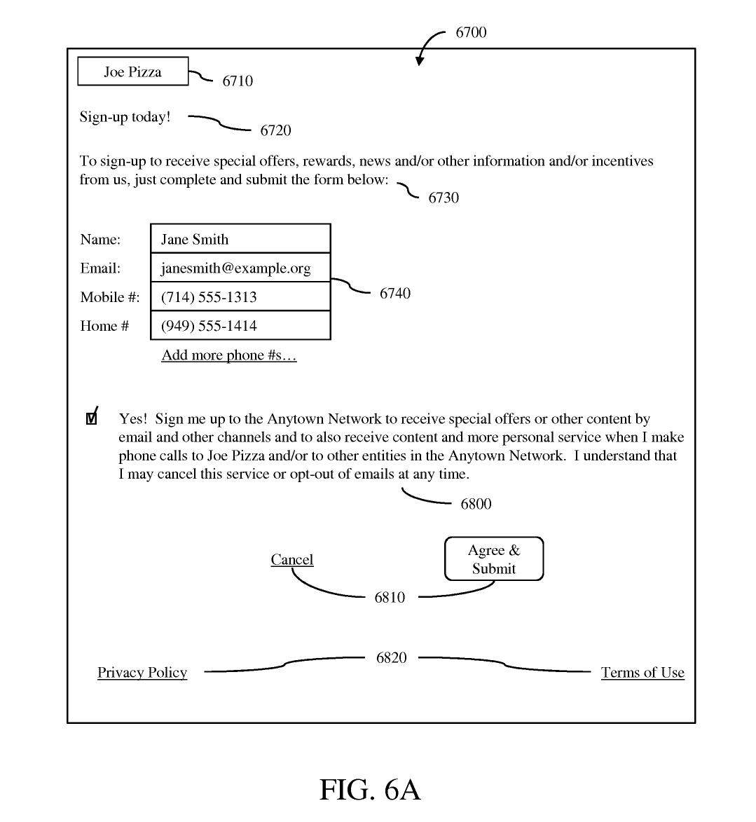

Continuing to look at FIG. 1, User Apps 1290 provide various user interfaces, features and/or functions to Users 1020 across a variety of channels, operating systems and/or Devices. For example, User Apps 1290 may be made available and/or accessed via online and/or web-based applications and/or forms, mobile devices and applications, interactive kiosks, offline forms, in-person and/or operator managed applications and/or a variety of other user/device/network/operating system combinations and/or configurations. User Apps 1290 may provide Users 1020 with a variety of features and functions as part of and/or related to the subject technology. For example, these Apps 1290 may provide Users 1020 with ways to: opt-in to receive content and features from SNs 1240 and/or Entities 1260; enter and/or manage their personal information, including names, UPNs, email addresses, physical addresses, billing information, etc.; manage their opt-in subscriptions and/or content; opt-in and/or opt-out to any number of SNs 1240 and/or Entities 1260 and/or content; share and/or block their data from any number or variety of SNs 1240 and/or Entities 1260; receive and/or manage their content subscriptions; manage their content types, frequencies, etc.; and a variety of other services and/or features. Data, settings, preferences, products and/or services and/or other information related to Users 1020 and/or User Apps 1290 and/or other information may be stored and/or accessed via User Database(s) 1200. Some example User App 1290 interfaces and/or related content are shown in FIGS. 6, 6A, 7, 9, 9A and are further described below.

Continuing to look at FIG. 1, Entity Apps 1310 and provide various user interfaces, features and/or functions to Entities 1260 across a variety of channels, operating systems and/or Devices. For example, Entity Apps 1310 made be made available and/or accessed via online and/or web-based applications and/or forms, mobile devices and applications, offline forms, in-person and/or operator managed applications and/or a variety of other user/device/network/operating system combinations and/or configurations. Entity Apps 1310 may provide Entities 1260 and/or their employees and/or agencies or other representatives and/or users with a variety of features and functions as part of and/or related to the subject technology. For example, these Apps 1310 may provide Entities 1310 with ways to: enter and/or manage their business profile(s) such as locations and hours of operation, contact information, business phone numbers, websites, etc.; enter and/or manage their products, services, offers, promotions and/or other incentives; enter and/or manage content to be distributed to Users 1020 via SNs 1240; sign-up for and/or manage membership with SNs 1240; enter and/or manage information related to their ASPs and other email configuration and/or User 1020 opt-in and/or User 1020 email address delivering settings; create and/or manage application programming interfaces (“APIs”) which may connect to various Entity 1260 applications and/or ASPs and/or applications; enter and/or manage payment and billing information and view billing history; receive reporting related to User 1020 activity and/or phone calls and/or other email activity and/or other history; and/or receive a variety of other options, settings, services and/or features. In addition, data, settings, preferences, products and/or services, content and/or other information related to Entities 1260 and/or Entity Apps 1310 and/or other information may be stored and/or accessed via Entity Database(s) 1300.

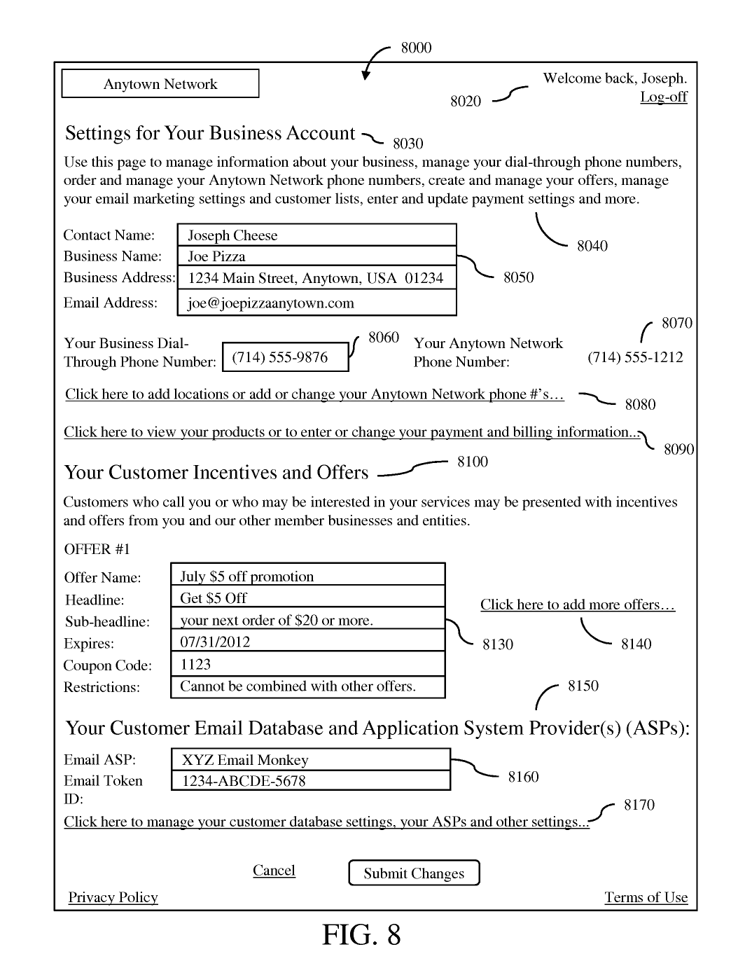

Employees and/or owners and/or other representatives of the Entities 1260 may use and/or access Entity 1260 accounts and/or Entity Apps 1310 and/or similar features and/or information and/or functions provided by each. Agencies, representatives, SNs 1240 and/or other 3^{rd} parties may be granted access and/or use of the Entity Apps 1310, for example to enter and/or update offers and/or other settings and/or information on behalf of Entities 1260. Entities 1260 may have a plurality of SN 1240 accounts and/or Entity Apps and/or they may have multiple users within the same SN 1240 accounts and/or Entity Apps 1310. An example of an Entity App 1310 interface is shown in FIG. 8 and is further described below. Also within FIG. 1, the example representing the Entity Database 1300 may include various information and/or settings and/or profiles, for example, Entity 1260 account information; business and/or user profiles; business information; content (offers, ads, promotions, news, incentives, products and/or other); ASP information and/or access authorization; reporting, for example related to Entity 1260 advertising (such as impressions, clicks, User call rates, coupon success rates, etc.); Entity App 1310 users and/or settings; and/or other settings and/or information.

Continuing in FIG. 1, Entities 1260 and their employees/users, Devices and/or Apps may be connected to the Internet and/or Other Networks 1140 as shown with example connection(s) 1092. SNs 1240 may connect to these Entities 1260 via the Entity Apps 1310 and/or application programming interfaces (“APIs”) and/or other methods and/or via Entity 1260 network connections 1092 to exchange data, for example User 1020 opt-in statuses, content, etc. Entities 1260 may have a variety of ways to store their opted-in User 1020 profiles and User 1020 data and/or to deliver content to their opt-in Users 1020. With example Entity A 1262, no User 1020 database is shown and it is possible that example Entity A 1262 may not store its User 1020 opt-in information and/or send content to opted-in Users 1020. However, Entity A 1262 may still have an associated SNPN 1030 and/or participate in and/or be included in content distributed via the SN 1262 to various Users 1020 who are opted-in and/or eligible for Entity A 1262 content, for example via “recommended offers” and/or other digest content.

With example Entity B 1264, its opt-in User Database 1266 is shown as being internally hosted and/or directly connected and Entity B 1264 may have its own direct communications and/or content delivery to its opt-in Users 1020, possibly in addition to content delivered via SNs 1240. Entity B 1264 may send email content to it Users 1020 via its own email servers and/or services as no external email application service provider (“ASP”) is shown. With Entity C 1268, it may have an external ASP 1270 and ASP database 1272 which may house its opted-in User 1020 database(s), email content, email delivery, etc. ASPs 1270 and/or their databases 1272 may connect to SNs 1240 through the Internet and/or Other Networks 1140 to exchange information and/or provide services, for example to add and/or update User 1020 opt-in statuses, email content, etc.

Continuing in FIG. 1, example Agencies 1274 are shown and may be connected to the system 1000 via the Internet and/or Other Networks 1140. Agencies 1274 represent Entities, including their respective users, devices, interfaces and networks, that provide an avenue for other Entities (not shown) to outsource some or all of their interactions with system 1000. Thus, instead of those Entities directly interacting with system 1000, Agencies 1274 may handle some or all of those interactions. For example, Agencies 1274 may be hired by a business to handle that business's subscription, offer, database, and/or other interactions with system 1000. The term “Entities” as used herein can include such Agencies 1274.

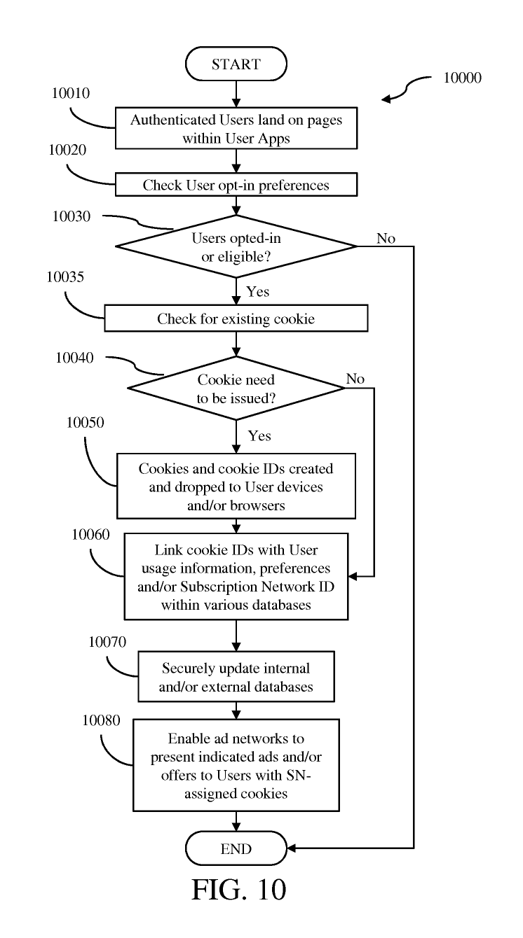

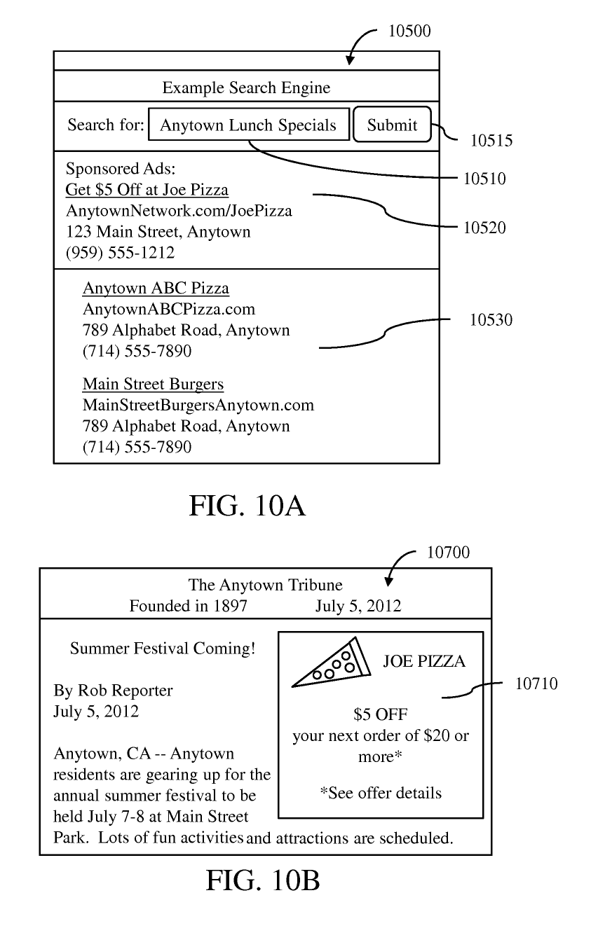

Continuing in FIG. 1, example Ad Networks 1276 are shown and may be connected to the system 1000 via the Internet and/or Other Networks 1140. Ad Networks 1276 include their respective users, devices, interfaces and networks. Further described below, opt-in content, for example advertising, may come into the SN 1240 as supplied via these Ad Networks 1276. Further, opt-in content and or advertising may be distributed to these Ad Networks 1276, and then to Users 1020 via opt-in and cookies, across various channels, for example via text, banner, email or video ads. Ad Networks 1276 may be run by the SN 1240, by an Entity 1260 or groups of Entities 1260, Agencies 1274, or any other entity or entities. An example process for issuing these cookies to Users 1020 is further illustrated in FIG. 10 and further described below. These cookies may enable various Ad Networks 1276 to deliver personalized and/or opt-in advertising and/or content to Users 1020. Examples of these ads distributed via Ad Networks 1276 are shown in FIGS. 10A and 10B and further described below.

Continuing in FIG. 1, a Pricing and Payment Engine 1320 may provide a variety of functions and/or features within a system 1000 and/or SNs 1240. For example, a Pricing and Payment Engine 1320 may provide: product, service and/or pricing tables for free, promotional and/or paid products and/or services offered to Users 1020 and/or Entities 1260; secure receiving and storing of credit cards and/or other payment information; connections and/or interactions with payment and/or billing gateways and/or networks; transmission and/or collection and/or transfer of funds to and/or from SNs 1240 and/or Users 1020 and/or Entities 1260; and/or provide a variety of other options, settings, services and/or features.

In some instances, SN 1240 services and/or features, including opt-in related services, can also be provided to Users 1020 after “dial-through” SNPN 1030 calls are transferred to destination entity numbers 1032. These post-dial-through services may be provided during the same call sessions (but post, Entity calls)—or after the calls have completely terminated, via automated or human call-backs to UPNs. For example, opt-in may be obtained after User 1020 call sessions with Entities 1260 have ended, whereby the IVR and Phone Tree Engine 1160 could notify calling Users 1020 at some point in those call sessions, “At the end of your call with Joe Pizza, stay on the line to sign-up to receive special offers . . . ”. Alternatively, after User 1020 call sessions with Entities 1260 completely end, the IVR and Phone Tree Engine 1160 and/or human operators may call Users 1020 back with similar services and offers, “Thank you for your recent call to Joe Pizza, to get $5 off your next order, press ‘1’ . . . ” or similar.

Continuing to FIG. 2, this shows a high-level block diagram further illustrating some components in FIG. 1; such as an example environment and system with example components for an interactive voice response (“IVR”) and phone tree engine; and is described in the present disclosure. As shown in FIG. 2, an IVR and Phone Tree Engine 1160 may consist of several components and/or sub-systems, some of which are illustrated. For example, an IVR and Phone Tree Engine 1160 may include an IVR and Phone Tree 2020, a SNPN Host and Caller ID Reader 2030, an Invitation Engine 2040 and/or an Audio File and Invitation Database 2060. Within an IVR and Phone Tree Engine 1160, as mentioned above, an IVR and Phone Tree 2020 may be used within the subject technology to provide and/or receive information and/or manage the flow of User 1020 phone calls placed to SNPNs 1030. For example, the IVR and Phone Tree 2020 may provide: interactive voice menus during User 1020 phone calls; information and/or prompting Users 1020 for inputs, sometimes in the form of phone keypad entry and/or voice responses; collection and recording of User 1020 inputs and/or data; managing decision-trees related to various paths to send User 1020 calls; interaction with other components in the system 1000 and SNs 1240; and/or other features, functions and/or services.

Messages, prompts, phone tree options, confirmations and/or sounds, etc. may be stored and/or programmed into the IVR and Phone Tree 2020 and/or the Audio File and Invitation Database 2060 and/or may include audio files and/or text-to-speech (“TTS”) instructions and/or any full or partial combinations of these and/or data from other sources, such as the User Database 1200. For example, the IVR and Phone Tree 2020 may play the following greeting during a call placed to a SNPN by a returning, opted-in User 1020: “Welcome back, Jane.” In this example, the “Welcome back” portion may come from a recorded audio file stored in the Audio Database 2060 and the “Jane” portion may come from a TTS instruction using the “[first_name]” variable or similar combined with the User 1020 data field coming from the User Database 1200.

Continuing to look at FIG. 2, a SNPN Host and Caller ID Reader 2030 may provide hosting of the SNPN 1030 phone numbers and/or phone technologies, including reading and/or processing Caller ID and/or other User 1020 call related information, phone call duration and/or other call session related information; and/or other features, functions and/or services. An Invitation Engine 2040 and/or an Audio File and Invitation Database 2060 may provide: rules and/or logic related to presenting opt-in incentives and/or other offers to Users 1020 calling SNPNs 1030; rules and/or logic as well as audio files and/or text-to-speech programs to be played to Users 1020 at various points within User 1020 phone call sessions; and/or other features, functions and/or services. An Invitation Engine 2040 and/or an Audio File and Invitation Database 2060 may play various invitations, incentives, offers and/or audio files or text-to-speech messages based on User 1020 types, User 1020 physical locations and/or UPN characteristics (for example, Users' Area Codes), called Entity 1260 types and/or locations, various other User 1020 and/or Entity 1260 groupings, and/or other factors. An Invitation Engine 2040 manages the delivery of the invitation messages played to calling Users 1020 and messages may be customized, tested and/or provided as voice recorded messages and/or played via text-to-speech technologies. SNs 1240 and/or Entities 1260 may provide offers and/or incentives (for example, a discount coupon) to entice calling Users 1020 to opt-in and/or for other reasons.

Continuing to FIG. 3, this shows a high-level block diagram further illustrating some components shown in FIG. 1, such as an example environment and system with example components for an opt-in engine, and is described in the present disclosure. In FIG. 3, an Opt-In Engine 1180 may consist of components, some of which are illustrated. For example, components of the Opt-In Engine 1180 may include a Speech-to-Text Transcriber 3020, an Email Address Parser 3040, a Parser Resource Database 3050 and/or a Human-Assisted Process 3060. A Speech-to-Text Transcriber 3020 may be used, within the system 1000 and/or SNs 1240, for example, in conjunction with the IVR and Phone Tree Engine 1160, to receive and process User 1020 voice audio recordings and/or other User 1020 inputs made during User 1020 phone calls sessions to SNPNs 1030. User 1020 voice recordings may consist of Users 1020 verbally speaking and/or spelling and/or otherwise providing their email addresses which may be used in a variety of ways by the subject technology, for example storing this information and/or any opt-in settings in User Database(s) 1200 and/or Entity Database(s) 1300. A Speech-to-Text Transcriber 3020 may also be used to process User 1020 voice recordings and/or produce and/or analyze text-based transcriptions of User 1020 voice recordings.

Continuing to look at FIG. 3, an Email Address Parser 3040 may receive and/or analyze and/or process information generated by the Speech-to-Text Transcriber 3020 and/or may scan for recognizable content, including content in the form of email addresses. An Email Address Parser 3040 may also access a Parser Resource Database 3050 which may store and/or regularly update common email address rules and/or formats and/or content. For example, an Email Address Parser 3040, in conjunction with information in the Parser Resource Database 3050, may look for text within User 1020 voice recording transcriptions such as the “@” sign, periods “.”, “.com” and/or other domains and/or subdomains, person names such as “jane.smith” and/or thing names, such “bluedolphin,” and/or years, such as “2012,” etc. An Email Address Parser 3020 and/or the Parser Resource Database 3050 may have rule sets and/or “learn” as they process and/or parse more email addresses, frequently adding to and/or improving the ability of the system 1000 to parse valid email addresses based on User 1020 voice recordings and transcriptions. An Email Address Parser 3040 may also, based on its data and/or rules sets and/or based on information exchanged with the Parser Resource Database 3050, assign a “confidence” score based upon how much confidence may be associated with parsing valid User 1020 email addresses from voice recordings and/or transcriptions.

In cases where, for given Users 1020, there is more than one User 1020 transcription for each User 1020, the Email Address Parser 3020 may also compare each transcribed email address to see if there may be one or more matched addresses. An Email Address Parser 3040 may look for not only exact matches in email addresses, but also variations in the format and/or spelling of various words and/or phrases within email addresses and/or variations in the transcriptions and/or formats related to the multiple email addresses collected. For example, an Email Address Parser 3040, with or without a Parser Resource Database 3050, may determine that the text of a first User 1020 voice recording, “jane.smith@example.org,” is high-confidence match with the transcribed text of a second User 1020 voice recording, “jane dot smith at example dot org.”

Continuing with FIG. 3, in various examples, if the Email Address Parser 3040 may not assign high confidence scores and/or matches (where multiple voice recordings are available) for valid User 1020 email addresses, the corresponding User 1020 voice recordings and/or parsed text components and/or confidence score data may be transmitted and used within a Human-Assisted Process 3060. A Human-Assisted Process 206 may include a semi-automated use of a call center and/or a pool of human workers and/or operators who may be available, trained and/or able to quickly access and/or review all of the information to see if valid User 1020 email addresses may be confidently determined. These human operators may also send Users 1020 back through various processes to obtain additional voice recordings and/or they may send SMS text messages and/or call users back to obtain valid email addresses for Users 1020. In portions of and/or complete steps, processes, features and/or services, it may be possible that live human phone operators and/or the Human Assisted Process 3060 may provide various manual and/or semi-automated functions, otherwise and/or also performed by the IVR and Phone Tree Engine 1160. Human operators in the Human-Assisted Process 3060 may perform a variety of other tasks and/or operations related to the subject technology.

In examples where a high confidence score has been reached, as determined by SN 1240 settings and/or rule sets, that valid email addresses have been obtained, an Opt-in Engine 1180 may record User 1020 email addresses and/or related information, such as User 1020 opt-in statuses, names, UPNs, etc., into User Database(s) 1200 and/or Entity Database(s) 1300 and/or may also record related call session data and/or other information from the IVR and Phone Tree Engine 1160 and/or other sources.

FIGS. 4, 4A, 4B, 4C, 4D, 4E, 4F and 4G are generally flow diagrams illustrating various example process flows performed via various components and providing various features; for example phone-related and/or phone call session features, opt-in, email address opt-in and/or collection, human operator flows, subscription-related features, security and/or verification features and/or other features provided to users and/or entities; and are described in the present disclosure.

Briefly, from the perspective of an entity that operates or provides access to an SN that is used to communicate with Users, one aspect of the subject technology may be a method of providing access to a subscription network that permits at least one user to opt-in to receive communications, information or offers from entities that interact with or operate the subscription network. The method may include the steps of providing one or more interfaces to the subscription network for at least one user, at least one of a plurality of entities that interact with or operate the subscription network to communicate with the user, or both; receiving information provided by the user for receipt by at least a first entity of the plurality of entities that interact with or operate the subscription network; and providing the information for receipt by at least a second entity of the plurality of entities that interact with or operate the subscription network, with the second entity different from the first entity. These interactions generally relate to business-to-business settings, but are not limited to such.

The one or more interfaces may be provided over the Internet, a computer network other than the Internet, a telephone device, or some combination thereof, and the information provided by the user may be received in the form of an identified phone number from which the user calls. The method may include additional steps, for example accessing a database of information provided by the at least one of the user, and generating, from the database, the information for receipt by at least the second entity of the plurality of entities that interact with or operate the subscription network.

From the perspective of an entity that interacts with or operates an SN to communicate with Users (e.g., a business, a SN operator, an Advertising Agency, an Advertising Network, any entity that provides or facilitates interactions with users on behalf of such entities, or the like), one aspect of the subject technology may be a method of permitting at least one user to opt-in to receive communications, information or offers from entities that interact with or operate a subscription network. The method may include the steps of receiving information from the user through an interface to the subscription network, the information for receipt by at least a first entity of the plurality of entities that interact with or operate the subscription network to communicate with users; and transmitting at least one of the communications, information or offers from a second entity that interacts with or operates the subscription network to the user, with the first entity different from the second entity. These interactions generally relate to business-to-consumer (i.e., business-to-User) settings, possible through intermediaries, but are not limited to such.

The information received from the user may opt the user into receiving the at least one of the communications, information or offers from the second entity, and the information received from the user may be received in the form of an identified phone number from which the user calls. The method may include additional steps, for example accessing a database of information provided by the user, and generating, from the database, the at least one of the communications, information or offers sent to the user.

The terms “interact with” and “interacts with” may broadly include direct interactions, indirect interactions through one or more intermediaries, or both. For example, the various interfaces discussed in the foregoing paragraphs may be provided by or through the first entity, the second entity, one or more subscription network operators, one or more application service providers, one or more advertising services, one or more advertising networks, or some combination thereof. The first and second entities may be businesses to which the communications, information or offers apply or those who provide services to such business, including but not limited to the examples of those by or through which the interfaces may be provided. In addition, the terms “communication, information or offer” and “communications, information or offers” broadly describe any combination thereof and may include content, interfaces, access information for interfaces (e.g., phone numbers, web addresses, or the like), features, advertisements, cookies, offers, inquiries, data, and any other type of information that may be communicated to a user. The subject technology may be used and/or facilitated by different entities than those discussed above, and the subject technology is not limited to the foregoing briefly described aspects.

Looking to FIG. 4, this shows the start of an example process 4000 and example flow diagram related to providing User 1020 opt-in and/or other various services and/or features for Users 1020 calling SNPNs 1030. Prior to the start of the process 4000, Users 1020 may see SNPNs 1030 via any number and/or combinations of communication channels and/or methods. For example, SNPNs 1030 may be seen by Users 1020 in user application messages, advertisements, business cards, websites, social media profile pages, social media and/or banner ads, in-person displays, online and/or App and/or offline directories, online or offline displays and/or ads, television shows and/or displays, yellow pages, flyers, direct mail and/or any other displays where telephone numbers may be displayed and seen by Users 1020. Beginning with Step 4020, User 1020 phone calls may be received by SNs 1240 via SNPNs 1030. In step 4040, the IVR and Phone Tree Engine 1160 may be started and, to inform Users 1020 that the call is being powered by the SN 1240 and/or that the call may be recorded (if desired or needed), audio message(s) and/or TTS message(s) may be played to calling Users 1020 via the IVR and Phone Tree 2020. Audio files and/or TTS messages may be retrieved from the Audio File Database 2060.

For example, one message that might be played via step 4040 could be, “This call is powered by Anytown Network and may be recorded . . . ” In step 4060, any calling User 1020 information, such as “Caller ID,” may be retrieved by the SNPN Host and Caller ID Reader 2030 if made available and retrievable for calling Users 1020 and their telephone carrier(s) and/or not blocked by Users 1020 or otherwise. This information may include Users' 1020 first and/or last names and/or initials, the Users' phone numbers (“UPNs”), business name(s) and/or other information. In step 4080, Caller ID or similar information may be examined by the IVR and Phone Tree Engine 1160 to identify and/or retrieve the Users' phone numbers (“UPNs”), if found in a proper and/or valid phone number formats (such as “949-555-1212”).

Continuing with FIG. 4, in decision block 4100, Caller ID information related to Users 1020 may be examined to determine if UPNs are available and/or verifiable. If UPNs are available/readable (“Yes”), then the process moves to step 4120 or, if not available (“No”), the example process 4000 may move to sub-process “A,” which is further illustrated in FIG. 4A, process 4300, and is described below. Next, in step 4120, the User Database 1200 may be consulted by the IVR and Phone Tree Engine 1160 to see if UPNs may be matched with existing UPNs in the User Database 1200. In decision block 4140, if UPNs are new to the User Database 1200 (“Yes”), the example process flow 4000 moves to step 4160. In decision block 4140, if the UPNs are not new to the User Database 1200 (“No”), then example flow 4000 may move to decision block 4150.

Next, in step 4160, the Invitation Engine 2040 is initiated and/or one or more audio and/or TTS messages may be played and/or phone tree options may be provided by the IVR and Phone Tree Engine 1160, inviting calling Users 1020 to opt-in to receive emails and/or other content and/or to opt-in to data exchanges and/or subscription(s) to content and/or other services via the SN 1240 and/or via one or more Entities 1260. In step 4160, via the Invitation Engine 2040, various rule sets and/or factors may be analyzed to determine which, if any, audio and/or TTS messages may be retrieved via the Audio File Database 2060 and played to calling Users 1020 and/or which phone tree options should be presented and/or corresponding User 1020 inputs received. Messages and/or phone tree options may be evaluated and/or determined by the Invitation Engine 2040 rule sets and/or factors, for example Users' Area Codes, Users' membership to various demographic or other groups, and/or any rule sets and/or factors related to and/or specified by Entities 1260 and/or SNs 1240. The invitation messages and/or phone tree options may also include various incentives to entice Users 1020 to opt-in. Additionally, in order to inform Users 1020 about privacy information, a message or TTS may be played to describing how Users' 1020 information may be stored and/or used and/or providing a website address Users 1020 may visit to learn more, such as “AnytownNetwork.com/privacy.” In addition, in step 4160, one phone tree option may be for Users 1020 to skip the opt-in step in order to reach the called Entity 1260, via “dial-through.”

For example, one message and phone tree option set played to Users 1020 via step 4160 might be, “Thank you for calling Joe Pizza. To opt-in to receive emails and other content from Anytown Network and Joe Pizza and to receive a $5 off Joe Pizza coupon, please press or say ‘1.’ To continue with your call to Joe Pizza, hold on the line or press or say ‘2.’ To learn about our privacy policies, visit Anytown Network dot com slash privacy.” As shown, phone tree option 2 may be more likely to be presented with “Dial-Through” SNPNs 1030, in which calling Users 1020 may be transferred to the called Entities 1260 (in this case, Joe Pizza) at the end of Users' 1020 call sessions. Alternatively, with a “Subscribe” SNPNs 1030, whereby calling Users 1020 may likely be calling specifically to opt-in and in which they may not need to be transferred to an Entity 1260 destination phone number 1032, the second message and phone tree option may alternatively be similar to: “Or, to end this call, press or say ‘2.’” In this example flow, while opting-in may opt calling users in to both the SN 1240 and the called Entity 1260, alternative flow and/or process examples may provide opt-in and/or opt-in options and/or messages for any number and/or combinations of SNs 1240, Entities 1260 and/or other parties.

In step 4180, the IVR and Phone Tree Engine 1160 may receive and/or record inputs from calling Users 1020. In the aforementioned example, if calling Users 1020 press the “1” button on their phones or say “one,” calling Users 1020 may be recorded in the User Database 1200 as opting-in to the SNs 1240 and the Entities 1260, thereby indicating a “Yes” answer to decision block 4200 and the example Users 1020 would then proceed to process “B,” which is further illustrated in FIG. 4B, process 4500, and is described below. Alternatively, using the aforementioned example Users 1020, these Users 1020 may choose to press or say “two,” or press or say some other number or may just wait, thereby indicating a “No” answer to decision block 4200.

Continuing in FIG. 4, in decision block 4200, the IVR and Phone Tree 1160, based upon the inputs received by calling Users 1020 in step 4180, may determine if Users 1020 have opted-in to one or more SNs 1240 and/or Entities 1260, for example from the invitation(s) given in step 4160. If calling Users 1020 have opted-in (a “Yes” answer to decision block 4200), the process flow 4000 moves to sub-process “B” further illustrated in FIG. 4B, process 4500, and described below. If calling Users 1020 have not opted-in (a “No” answer to decision block 4200), the process flow 4000 may then move to sub-process “E” as further illustrated in FIG. 4E, process 5200, and as described below.

Still within FIG. 4, returning to decision block 4140, if the UPNs are not new to the User Database 1200 (“No”), the process may move to decision block 4150. In decision block 4150, in matching the UPNs to existing UPN profiles in the User Database 1200, if the UPNs are determined by the IVR and Phone Tree Engine 1160 to already be opted-in (“Yes”), for example to the SN(s) 1240 and/or Entity or Entities 1260 which are part of the invitation in step 4160, the process moves to sub-process “D,” further illustrated in FIG. 4D, process 5000, and as described below. In decision block 4150, if the UPNs are determined to not be opted-in (“No”), the process may move to decision block 4152. In decision block 4152, the IVR and Phone Tree Engine 1160 may consult the User Database 1200 to determine if calling Users 1020 and their corresponding, non-opted-in UPNs may be eligible for one or more opt-in invitation(s) in step 4160, for example there are no blocks or other restrictions preventing the opt-in. In decision block 4152, if Users 1020 and their UPNs may be eligible for the opt-in invitation(s) (“Yes”), the process may move to step 4160 and continue as described above. If UPNs may not be eligible for opt-in invitation(s) (“No”), the process may move to sub-process “E” as further illustrated in FIG. 4E, process 5200, and as described below.

Continuing on to FIG. 4A, this shows an example sub-process “A,” process 4300, which may be a continuation of the example processes described above. In step 4360, similar to the flows starting with step 4160 described above, audio and/or TTS messages may be played and/or phone tree options may be provided by the IVR and Phone Tree Engine 1160, inviting calling Users 1020 to opt-in to receive email and/or other content and/or to opt-in to data exchanges and/or subscription(s) to content and/or other services via the SN 1240 and/or via one or more Entities 1260. In step 4360, via the Invitation Engine 2040, various rule sets and/or factors may be analyzed to determine which, if any, audio and/or TTS messages may be retrieved via the Audio File Database 2060 and played to calling Users 1020 and/or which phone tree options should be presented and/or corresponding User 1020 inputs received. Messages and/or phone tree options may be evaluated and/or determined by the Invitation Engine 2040 rule sets and/or factors, for example the Users' Area Codes, the Users' memberships to various demographic or other groups, and/or any rule sets and/or factors related to and/or specified by one or Entities 1260, including the called Entities 1260 and/or SNs 1240. The invitation messages and/or phone tree options may also include various incentives to entice Users 1020 to opt-in. Additionally, in order to inform Users 1020 about privacy information, a message or TTS may be played to describing how Users' 1020 information might be stored and/or used and/or providing a website address Users 1020 may visit to learn more, such as “AnytownNetwork.com/privacy.” In addition, in step 4360, one phone tree option may be for Users 1020 to skip the opt-in step in order to reach the called Entities 1260, via “dial-through.” Alternatively, with a “Subscribe” SNPNs 1030, whereby calling Users 1020 may be calling to opt-in and in which they may not need to be transferred to Entity 1260 destination phone numbers 1032, then messages and phone tree options may not provide a transfer option.

Next, in step 4380, the IVR and Phone Tree Engine 1160 may receive and/or record inputs from calling Users 1020. For example, using aforementioned examples, if calling Users 1020 press the “1” button on their phones or say “one,” calling Users 1020 may be recorded as opting-in to the SN 1240 and the Entity/Entities 1260, thereby indicating a “Yes” answer to decision block 4400 and the example Users 1020 would then proceed to step 4420. Alternatively, the Users 1020 may choose to press or say “two,” or press or say some other number or may just wait, thereby indicating a “No” answer to decision block 4400 and the process may continue to sub-process “E.”

Continuing in FIG. 4A, in decision block 4400, the IVR and Phone Tree 1160, based upon the inputs received by calling Users 1020 in step 4380, may determine if the Users 1020 have indicated a desire to opt-in to one or more of the SNs 1240 and/or Entities 1260, for example from the invitation(s) given in step 4360. If calling Users 1020 have opted-in (a “Yes” answer in decision block 4400), the process flow 4300 may move to step 4420. If calling Users 1020 have not opted-in (a “No” answer in decision block 4400), the process flow 4300 may then move to sub-process “E” as further illustrated in FIG. 4E, process 5200, and as described below.

Continuing in FIG. 4A, in step 4420, the IVR and Phone Tree Engine 1160 may play audio messages and/or use TTS and/or provide phone tree options to prompt calling Users 1020 to speak or enter one or more of their phone number(s) that they want to use as the identifiers for the opt-in(s) (or “UPNs”) to SNs 1240 and/or Entities 1260. For example, the IVR messages played may be similar to, “Please say or enter your ten-digit phone number, including area code, and then press the pound sign.” In some examples, Users 1020 may be able to provide one or more UPNs and/or the UPNs may be different from the phone numbers of the phones used in the Users' 1020 current call sessions. Alternatively in step 4420, the IVR and Phone Tree Engine 1160 may play audio messages and/or use TTS to suggest that Users 1020 call back from other phone lines and/or that they unblock Caller ID so that their UPNs may be read.

In step 4430, The IVR and Phone Tree Engine 1160 may receive User 1020 voice and/or keypad inputs, detects any errors and/or prompts the Users 1020 and/or plays other confirmation messages as desired and/or specified. In step 4440, the IVR and Phone Tree Engine 1160 may parse the User 1020 inputs to collect and/or store UPNs to be associated with User 1020 profiles and/or opt-ins. In decision block 4442, the IVR and Phone Tree Engine 1160 rule sets and/or settings, if desired and/or specified, may require a call-back and/or text-back security and/or verification process to ensure that the UPNs provided by the calling Users 1020 are valid and/or owned by calling Users 1020. In decision block 4442, if such a validation process may be desired and/or specified (“Yes”), the process 4300 may move to sub-process “F,” which is further illustrated in FIG. 4F and further described below. In decision block 4442, if no validation process is desired and/or specified (“No”), the process 4300 may continue to step 4460. In step 4460, the IVR and Phone Tree Engine 1160 may compare the entered UPNs with UPNs in the User Database, may handle any matches found, catch an errors and/or prompt Users if/when needed to correct problems and/or address any issues. In step 4480, once the UPNs are validated and stored with Users' profiles in the User Database 1200, the IVR and Phone Tree Engine 1160 may play any audio and/or TTS confirmation and/or “thank you” messages to Users 1020 and the process continues to sub-process “B,” which is further illustrated in FIG. 4B and described below.

Next, FIG. 4B, sub-process “B,” also shown as process 4500, may be a continuation from previously described process 4000 and/or process 4300. Sub-process “B” may be used, among other functions, to collect and/or store User 1020 email addresses to be used in various opt-ins and/or other ways. In step 4540, the IVR and Phone Tree Engine 1160 audio and/or TTS messages may prompt Users 1020 to speak their email addresses to be used in the opt-in via message(s) such as, “Speaking slowly and clearly, please say and then spell your email address” and/or similar message(s). The email addresses may be requested as the email addresses to which Users 1020 want to associate with their UPN identifiers and/or opt-in to SNs 1240 and/or Entities 1260. While it may be desirable or specified to request that Users 1020 both say and spell their email addresses, one or both of these inputs may be requested through the IVR messages, as well as other variations of email address inputs and/or formats. For example, a User 1020 may say her email as “jane smith at example dot org” in addition to spelling her email as “J-A-N-E-S-M-I-T-H at E-X-A-M-P-L-E dot O-R-G”. Requesting multiple types of input from Users 1020 may be desirable and/or preferred in order to have two or more points of comparison when parsing the email addresses and/or assigning a confidence level. Requesting more than one input type may also help the Speech-to-Text Transcriber 3020 and/or the Email Address Parser 3040 and to produce higher quality email address matches and/or with higher confidence scores. Alternatively, it may be possible that parts of the email addresses be requested, such as “ . . . say and spell your email screen name . . . now say and spell your email domain . . . ”, or similar. In step 4560, the IVR and Phone Tree Engine 1160 waits for and then collects and stores User 1020 voice recordings. In step 4580, “Thank you” or similar confirmation audio and/or TTS messages may be played by the IVR and Phone Tree Engine 1160.

Next, in decision block 4582, rule sets and/or settings in the IVR and Phone Tree Engine 1160 may determine if additional User 1020 email address voice recordings are desired and/or specified. For example, the quality of the email address transcriptions using the first recordings may be high enough and/or the parsing rules good enough, based on a variety of factors, that only one voice recording be obtained per User 1020. In preferred examples, though not required, it may be likely that two (or more) User 1020 voice recordings would be obtained per User 1020. With at least two recordings obtained, the multiple resulting text transcriptions may be compared with each other which may produce better results and/or which may have a higher confidence levels that Users' 1020 correct email addresses have been obtained. In decision block 4582, if another recording may be desired or specified (“Yes”), the process moves to step 4600. If no additional recordings are desired or specified (“No”), the process skips to sub-process “C,” which is illustrated in FIG. 4C and further described below. Step 4600 may be similar and/or identical to step 4540, while, alternatively, the IVR and Phone Tree 1160 message(s) may acknowledge that subsequent recordings are being requested. For example, “Once again, please say and then spell your email address . . . ” or “One more time, please say and then spell your email address . . . ” Steps 4620 and 4640 are similar to steps 4560 and 4580 where subsequent recording(s) are stored and “Thank you” confirmation message(s) are played to Users 1020.

Continuing to look at FIG. 4B, once sub-process “C” has been completed and the flow returns to process 4500, step 4650 illustrates a potential sub-process whereby additional steps and/or processes, not detailed herein, may be used. These steps may include using TTS and/or live telephone operators to read back the parsed email addresses to Users 1020 to confirm the correct addresses to be stored and/or used. If validated by Users 1020, the process may continue, or, if not validated, additional User 1020 voice recordings and/or live operators may be used to assist in obtaining valid User 1020 email addresses. Next, in step 4680, information, including User 1020 email addresses, opt-in settings, names, and/or any other collected and/or specified information may be stored and/or user profiles may be created and/or updated within User Database(s) 1200 and/or Entity 1260 database(s) and/or ASP Database(s) 1272. In step 4700, “Thank you for subscribing” and/or similar audio and/or TTS messages may be played by the IVR and Phone Tree Engine 1160. In step 4720, if desired or specified, the Content and Delivery Engine 1280 may run to create and/or send content, via email and/or other channels, confirmation emails and/or offers and/or verification emails to Users 1020 at their email addresses and/or other channels, for example, within the online logins of their SN 1240 accounts.

In some example processes and SNs 1240, it may be desirable and/or specified to perform email-based and/or phone-based verification steps to confirm User 1020 emails and/or UPNs and/or User 1020 identities. In decision block 4725, if additional phone and/or email verifications are indicated (“Phone” and/or “Email”), the process flow may move to sub-process “F” (for phone verification) and/or sub-process “G” (for email verification) and either or both of these sub-processes may be completed simultaneously and/or in any order and/or any combination. These example sub-processes are further illustrated in FIGS. 4F and 4G and described below. In some example process flows, completion of one or both of these verifications may be required to continue current call session processes, and/or they may be completed offline and/or at a later time. If one or both of these verifications are specified before continuing and one or both of them fail and/or are not completed, then additional system and/or operator interaction may be required and/or fail related messaging delivered before the flow may continue to sub-process “E.” If, in decision block 4725 these sub-process verifications are not indicated to be completed before continuing in the process (“No”), the flow may continue to decision block 4730.

Continuing with FIG. 4B, in decision block 4730, the IVR and Phone Tree Engine 1160 may determine, based on settings and/or rule sets and/or other specifications, if additional audio and/or TTS messages should be played (for example, audio offer messages played to new subscribers), user inputs requested and/or received, phone tree options presented, and/or if other tasks and/or services should take place during Users' 1020 current call sessions. In decision block 4730, if all desired and/or specified call session tasks are completed (“Yes”), the process moves to sub-process “E,” which is illustrated in FIG. 4E, process 5200, and described below. In decision block 4730, if all desired or specified tasks have not yet been completed (“No”), the process 4500 may continue to sub-process “D,” which is illustrated in FIG. 4D, process flow 5000, and described below.

FIG. 4C illustrates example sub-process flow “C,” also described as process 4800, which may be a continuation of the example processes described above, in which, among other steps, User 1020 voice recordings and/or other inputs are used to create digital, valid, and/or opted-in User 1020 email addresses by turning recordings into text using STT, parsing email addresses into proper formats, comparing multiple versions, using human operators (where needed) and/or other processes and/or steps. Like other processes described, this process may be initiated and/or completed simultaneously with and/or after other processes and/or during and/or after User call sessions. In step 4810, the Opt-In Engine 1180 may be initiated. In step 4820, the Speech-to-Text Transcriber 3020 may be initiated and may convert one or more of the collected User 1020 voice recordings into digital text strings and/or text files. In step 4830, an Email Address Parser 3040 may be initiated in conjunction with a Parser Resource Database 3050 to find and/or “parse out” email addresses contained within transcribed text strings and/or text files which may have been obtained in the above step(s).

As described previously, the Parser Resource Database 3050 may be used by the Email Address Parser 3040 to assist in parsing email addresses out of text strings by finding and/or matching common email address formats and/or rules and/or content such as the “@” sign, periods, “.com” and/or other domains and/or subdomains, person names, and/or thing names, etc. In step 4840, the Email Address Parser 3040 may compare the transcribed and/or parsed email addresses from multiple recorded sayings and/or spellings and/or multiple User 1020 voice recordings to find exact and/or closely matching email addresses. As previously described, the Email Address Parser 3040 may look for not only exact matches, but also variations in the format and/or spelling of various words and/or phrases within email addresses and/or variations in the transcriptions and/or formats related to the multiple email addresses collected. For example, “jane.smith@example.org” transcribed from a first voice recording may be a high-confidence match with the transcribed text of a second voice recording, “jane dot smith at example dot org.”

In step 4850, based on the available data and/or rule sets and/or settings and/or based upon information exchanged with the Parser Resource Database 3050, the Email Address Parser 3040 may assign email address “confidence scores” indicating the levels of confidence that valid email addresses have been obtained for corresponding Users 1020. For example, if two User 1020 voice recordings produce two identical transcribed digital text email addresses, a 99% or even 100% confidence score might be assigned. Alternatively, if two User 1020 voice recordings produce very different transcribed email addresses, a lower confidence score might be assigned. In decision block 4860, the IVR and Phone Tree Engine 1160 reads the email address confidence scores to determine if they may be high enough to assume that valid email addresses have been obtained. In decision block 4860, if high enough scores are reached (“Yes”), the process 4800 may continue to step 4910. If high enough scores have not been reached (“No”), the process 4800 may continue to step 4870. In step 4910, confirmed and/or valid User 1020 opt-in email addresses may be stored in SN User Database(s) 1200 and/or Entity 1260 database(s) and/or ASP database(s) 1272. The process 4800 then RETURNS to the previous process, in this example flow, process 4500, step 4650 (previously described above in FIG. B).

Continuing to look at FIG. 4C, process 4800, starting with step 4870, as previously described, human operators via the Human-Assisted Process 3060 may be utilized to further assist in obtaining User 1020 email addresses. In some example processes and/or SNs 1240 and/or SNPNs 1030, it may be desirable to skip all or portions of the automated processes, for example skipping steps 4820 through 4860, in order to go directly to Human-Assisted Process 3060 steps, for example starting with step 4870. Human operators/transcribers may be employees and/or contractors of SNs 1240 and/or be part of a call center and/or be part of some other entity and/or virtual and/or pooled resource. They may break up portions of these processes among operators and/or all processes may be done by one operator and they may utilize any manner of training, devices, software, networks, applications and/or workflow tools, etc.

Continuing to look at FIG. 4C, with the Human Assisted Process 3060, in step 4870, transcribed email addresses, User 1020 voice recordings, confidence scores, and/or any other desired and/or specified and/or available information may be securely transmitted to human operators/transcribers. In step 4880, human operators/transcribers may review all the available information and, consulting their own rules and/or operating procedures and/or confidence scores, determine if valid email addresses can be obtained. In decision block 4890, if valid email addresses are found and/or pass human operator scrutiny and/or pass operator versions of confidence score thresholds (“Yes”), the process moves to step 4900. If valid email addresses still may not be verified (“No”), the process moves to decision block 4920. In step 4900, human operators securely confirm and/or enter valid User 1020 email addresses into a shared SN 1240 database(s) and then the process continues to step 4910. In decision block 4920, while User 1020 calls are still in session and/or as specified, additional User 1020 voice recordings may be obtained by returning the call sessions and the processes back to step 4600. If this may be desired and/or specified (“Yes”) the process returns to step 4600. In decision block 4920, if additional call session User 1020 recordings are not desired or specified (“No”), the process may move to step 4930. Step 4930 may include a variety of additional steps and/or processes to obtain valid, opt-in User 1020 email addresses.

For example, while User 1020 calls are still in session, as alternatives to sending the process back to the automated IVR processes, live operators may “barge” into the calls to speak directly with calling Users 1020 to obtain their email addresses and/or to perform other functions. With additional examples in step 4930, human operators and/or automated call-backs and/or text-backs (depending on SMS opt-in) may take place, calling and/or texting UPNs to make additional attempts to obtain User 1020 email addresses. These additional example steps within step 4930 may take place during and/or after User 1020 call sessions. For User 1020 calls still in session, after any specified steps within step 4930 are completed, the example process flow may move to sub-process “E,” further illustrated in FIG. 4E, process 5200, and described below.

Continuing to FIG. 4D, which may be a continuation of the example processes described above, the process 5000 in this flow illustrates example call-session features, incentives and/or other services to Users 1020 who are opted-in to SNs 1240 and/or Entities 1260 via their respective UPNs and who may call SNPNs 1030. In step 5010, the IVR and Phone Tree Engine 1160 may play personalized greetings and/or phone tree options to Users 1020. For example, for the aforementioned, returning and opted-in User 1020 Jane Smith, an example audio message may be similar to, “Welcome back, Jane!” In decision block 5020, a check may be made, looking at Users' profiles in the User Database 1200 to determine if any of the previously described email and/or phone verifications may still be desired and/or specified. In decision block 5020, if additional phone and/or email verifications are indicated (“Phone” and/or “Email”), the process flow may move to sub-process “F” (for phone verification) and/or sub-process “G” (for email verification) and either or both of these sub-processes may be completed simultaneously and/or in any order and/or any combination. These example sub-processes are further illustrated in FIGS. 4F and 4G and described below.

In some example process flows, completion of one or both of these verifications may be required to continue current call sessions, and/or they may be completed offline and/or at a later time. In decision block 5020, if these sub-process verifications are not required to be completed before continuing in the process (“No”), the flow may continue to decision block 5050. If one or both of these verifications are specified before continuing and one or both of them fail and/or are not completed, indicated by a “No” in decision block 5030, then, in step 5040, additional system and/or operator interaction may be required and/or fail related messaging delivered before the flow may continue to sub-process “E.” In decision block 5030, if the phone and/or email verifications specified are successfully completed (“Yes”), then the process may move to decision block 5050.

Continuing in FIG. 4D, in some User 1020 call sessions, it may be desirable to verify calling User 1020 identity through additional means beyond reading their UPNs from Caller ID. For example, where personal and/or confidential information may be accessed in the call, where financial data or transactions may take place, where offers or incentives may only be presented to specific Users 1020 and/or other situations and/or examples where additional security verification may be desired by SNs 1240, Entities 1260 and/or for specific SNPNs and/or Users 1020 and/or groups of SNPNs and/or Users 1020. In decision block 5050, the IVR and Phone Tree Engine 1160 determines whether or not, for example by examining its criterion and/or rule sets and/or settings and/or settings for the SNPNs 1030 and/or User 1020 settings in Database(s) 1200, additional User 1020 security verification may be specified before continuing. In decision block 5050, if security verification may be needed (“Yes”), the process flow may move to step 5060. If no additional security verification may be needed (“No”), the process flow may move to step 5100.

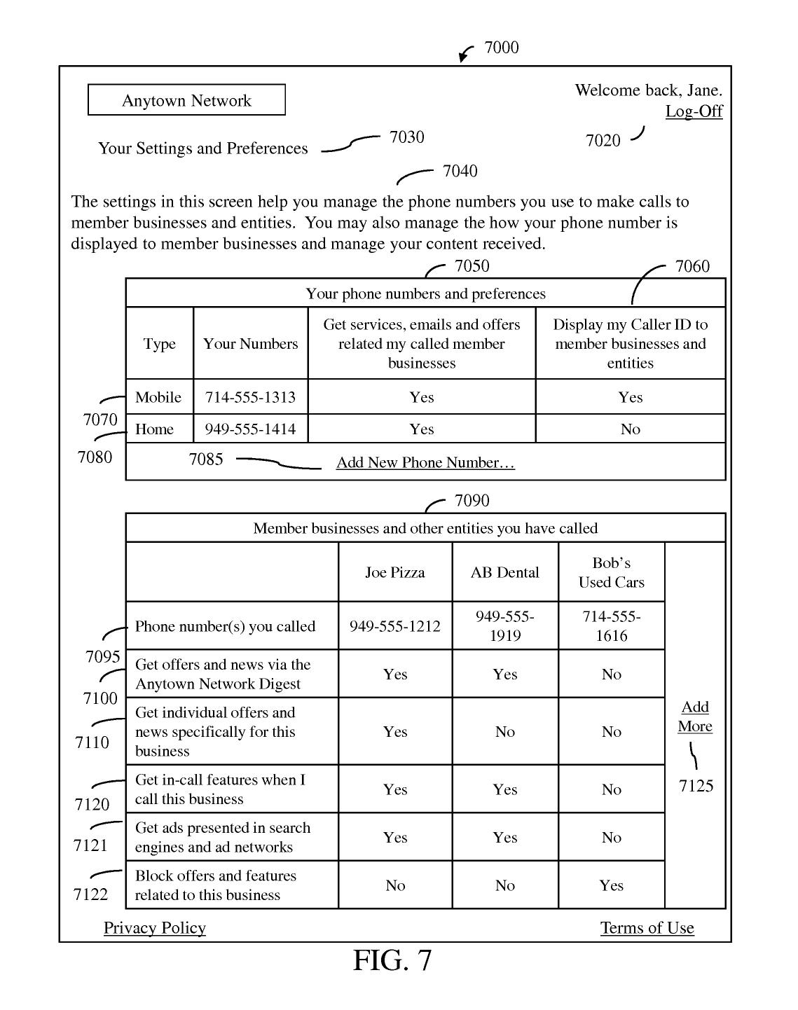

In step 5060, Users 1020 may be prompted by the IVR and Phone Tree Engine 1160 to security verify. This verification may take a variety of forms and/or methods using any manner of verification method and/or codes. For example, in User 1020 sign-up processes and/or settings interfaces in User Apps 1290, such as the sign-up processes described in these flows and/or the sign-up and/or User App 1290 setting interfaces illustrated in FIGS. 6, 6A and 7, Users 1020 may be asked to provide security password(s) and/or personal identification number(s) (“PINs”). These may be numeric and/or alphanumeric strings and/or an answer to a question (for example, “What year was your mother born?”) and/or any other security setting and/or code which may be verified in a User phone call session and/or which provide good security measures. These verification methods may also include, but are not limited to, keying or speaking a PIN, entering or speaking the last four digits of a social security number, verbally speaking a password or other word, answering personal/custom security questions (by keypad or speech), and/or speech pattern recognition technologies and/or other methods.

Continuing to decision block 5070, the IVR and Phone Tree 1160 may verify whether or not User 1020 inputs and/or responses to the security verifications to determine if Users 1020 have passed the verification screenings. In decision block 5070, when Users 1020 pass the verification (“Yes”), the process may move to Step 5100. In decision block 5070, if Users 1020 do not pass (“No”), then Users 1020 may continue to decision block 5080. In decision block 5080, if additional attempts are desired and/or Users 1020 are able to try again (“Yes”), human operator and/or automated processes may be run and/or Users 1020 may be return to previous steps, for example step 5060. If, in decision block 5080, additional security attempts are not specified and/or Users 1020 are not able to try again, security fail messaging and/or other steps are played and/or performed in step 5090 and the process continues to sub-process “E,” which is illustrated in FIG. 4E and described below.

In step 5100, the IVR and Phone Tree 1160 may execute any programmed and/or live operator and/or personalized audio and/or TTS greetings, messages, phone tree menu options and/or other personalized services and/or features. For example, Users 1020 may be presented with personalized offers, such as, “Thank you for being a loyal customer, Jane. Please press “1” to get a free pizza coupon by email!” In other examples, in step 5100, the Invitation Engine 2040 may determine which, if any, additional opt-in invitation messages might be played to Users 1020. If, for example, Users 1020 are opted-in to Joe Pizza, but not Anytown Car Wash, they might receive an audio message such as, “Thank you for being a part of the Anytown Network, Jane. To add the Anytown Car Wash to your opted-in business list, press or say ‘1,’ If you do not wish to add this subscription, just hold or press or say ‘2’ to continue your call.”

In step 5110, a variety of User 1020 inputs may be received, stored and used by the IVR and Phone Tree 1160 and/or live phone operators. For example, User 1020 inputs may include phone keypad entries, voice responses, phone tree menu selections and/or other inputs. In step 5120, the IVR and Phone Tree Engine 1160 and/or live phone operators may execute instructions which push out content, notifications, offers and/or messages to Users 1020 via the Content and Delivery Engine 1280, User Apps 1290 and/or other channels and/or communication methods. These notifications, content, offers and/or messages may take a plurality of forms and/or serve a plurality of functions and/or may be initiated at any point in the processes, including before, during and/or after call sessions. For example, continuing the aforementioned example, the free coupon from Joe Pizza could be created and then emailed by the Content and Delivery Engine 1290 to Jane Smith and/or she could receive the coupon in her SN 1240 account in when accessing User Apps 1290. In step 5130, various confirmation and/or closing messages and/or notifications may be executed by the IVR and Phone Tree Engine 1160 and/or by live human operators. Step 5130 may also include running the IVR and Phone Tree Engine 1160 to play messages thanking Users 1020 for using the system and/or to complete any other remaining call session actions. In step 5140, updates and/or information, for example data collected during the call session, may be posted to one or more databases, including the User Databases 1200, Entity 1260 databases and/or ASP Databases 1272 and/or other databases. The example process 5000 then continues to sub-process “E,” which is illustrated in FIG. 4E and described below.

Continuing to FIG. 4E, this process flow 5200 illustrates an example process which may be a continuation of the example processes described above and/or in which calls made by Users 1020 to SNPNs 1030 may be handled prior to those calls and/or User 1020 data being transferred and/or before this portion 5200 of the example processes ending. In decision block 5210, the IVR and Phone Tree Engine 1160 may determine whether or not the SNPNs 1030 dialed by Users 1020 in the flows are “dial-through” SNPNs 1030. As described previously, dial-through SNPNs 1030 may be used to carry out various tasks and/or processes before transferring User 1020 calls to destination phone numbers 1032 and/or Entities 1260. Dial-through SNPNs 1030 may be in contrast to “Subscribe” SNPNs 1030, which, for example, may not transfer to another destination number 1032 and/or may not be received by Entities 1260, but that may serve to specifically facilitate tasks, features and/or services related to the subject technologies. In decision block 5210, if SNPNs 1030 called are a Dial-Through SNPNs 1030 (“Yes”), the example process 5200 may continue to step 5220. If SNPNs 1030 are not Dial-Through SNPNs 1030 (“No”), the example process 5200 may END. In step 5220, the IVR and Phone Tree Engine 1160 may play various “Your call will now be transferred . . . ” audio and/or TTS messages and/or similar messages to calling Users 1020. In step 5230, the IVR and/or Phone Tree Engine 1160 and/or the Dial-Through Engine 1220 may read the User Database 1220 and/or other system 1000 settings and/or information to determine if calling Users' 1020 information, for example their Caller ID, UPNs and/or other information, should be displayed and/or otherwise shared and/or transmitted to Entities 1260 receiving the transferred phone calls.

In decision block 5240, if it may be determined that it is OK to send User 1020 data to Entities 1260 (“Yes”), the process 5200 may continue to step 5250. If, in decision block 5240, it may be determined that it is not OK to send User 1020 data to Entities 1260 (“No”), the process flow 5200 may continue to step 5260, where User 1020 calls may be transferred to receiving and/or destination phone numbers 1032 of Entities 1260 and then the example process 5200 may END. In step 5250, User 1020 calls may be transferred to receiving and/or destination phone numbers 1032 of Entities 1260 and User 1020 info may be transferred to Entities 1260 in various forms and/or methods, for example via Caller ID and/or UPNs appearing in any forms and/or combinations of Entity 1260 Devices, and/or Phones and/or other Entity Apps 1310 and/or other applications. Then, after step 5250, the example process 5200 may END.

Steps 5240 to 5260 can permit Users to set and manage, via user interfaces, how and/or when their information (e.g., Caller ID, entered email addresses, and/or information such as their call history or order history) gets transmitted to the called party such as one of Entities 1260. For example, a User 1020 could provide their UPNs one time via an interface to one of the SNs 1240 using any type of phone, email, web, text, or other access method, and that information could then be used for subsequent communications by the Entities 1260. As explained further below, the User 1020 could also later modify their contact information via various interfaces.

Continuing to FIG. 4F, which may be a continuation of the example processes described above, an example process flow diagram is shown illustrating an example process 5400, also described as sub-process “F,” for carrying out User 1020 phone verifications and/or other features and/or tasks. In decision block 5410, the IVR and Phone Tree 1160 may determine if Users 1020 are in session with calls placed to SNPNs 1030. If User 1020 SNPN 1030 calls are in session (“Yes”), the process 5400 may continue to step 5420. If calls are not in session (“No”), the process 5400 may continue to step 5440. In step 5420, live human operators and/or the IVR and Phone Tree Engine 1160 may say and/or play informational audio and/or TTS for example, “To ensure the security and privacy of your account, we will need to call or text you back at your registered phone number to verify your identity. Please press ‘1’ to receive a verification text message or press ‘2’ to receive a verification phone call . . . ” and/or similar. These messages and/or options may be customized based upon User 1020 scenarios, for example if Users 1020 are calling from phones identified by the system 1000 as mobile phones and/or they have an opted-in mobile UPN on file, text message verification options may be presented. In step 5430, various User 1020 inputs are received and/or recorded by the IVR and Phone Tree Engine 1160 and/or human operators.

In step 5440, a security code may be generated and/or used for User 1020 call-back and/or text back verifications. This code may be any variety of characters and/or formats, for example four-digit numbers, and/or may include User 1020 specified questions and/or answers and/or include speech recognition technologies. In another example, Users 1020 may provide their own voice recorded questions and/or answers related to the question, “What is your mother's maiden name?” Human operators and/or the IVR and Phone Tree Engine 1160 may then, in step 5450, call and/or send a text message to the UPNs and/or corresponding Users 1020 being verified and then may be prompted to speak and/or key enter responses to the security verification questions. Users 1020 may then respond and then, in step 5450, these responses are collected and compared by the IVR and Phone Tree Engine 1160 with the correct responses.

In decision block 5460, User 1020 responses are compared with the correct responses. If, in decision block 5460, if there is a match, then the security code is verified (“Yes”) and the process 5400 may continue to step 5480. If in decision block 5460, security codes are not verified (“No”), the process 5400 may continue to step 5470 whereby Users 1020 are notified of the verification failures and/or they may be provided with additional verification attempts. In decision block 5490, if no additional verification attempts may be specified and the process should be stopped (“Yes”), any messaging may be provided to Users 1020 and the process may continue to decision block 5500. If additional verification attempts are specified and/or the process 5400 should not stop (“No”), the process may return to step 5450. In step 5480, databases, for example User Databases 1200 and/or Entity 1260 databases are updated with the security validation results. In decision block 5500, if User 1020 call sessions are in progress (“Yes”), the process 5400 may RETURN to the next step in the previous process flow, just after the “F” sub-process was specified. If, in decision block 5500, User 1020 calls are not in session (“No”), the example process 5400 may END.

Continuing to FIG. 4G, which may be a continuation of the example processes described above, an example process flow diagram is shown illustrating an example process 5600, also described as sub-process “G,” for carrying out User 1020 email verifications and/or other features and/or tasks. In decision block 5610, the IVR and Phone Tree 1160 may determine if Users 1020 are in session with calls placed to SNPNs 1030. If User 1020 SNPN 1030 calls are in session (“Yes”), the process 5600 may continue to step 5620. If calls are not in session (“No”), the process 5600 may continue to step 5640. In step 5620, live human operators and/or the IVR and Phone Tree Engine 1160 may say and/or play informational audio and/or TTS for example, “To ensure the security and privacy of your account, we need to send you an email to verify your email address. Please press ‘1’ to receive this verification email now . . . ” and/or similar. In step 5630, various User 1020 inputs may be received and/or recorded by the IVR and Phone Tree Engine 1160 and/or human operators. In step 5640, the Content and Delivery Engine 1280 may generate a verification email with a security hyperlink. When this email is sent to User 1020 email addresses and then clicked upon, User 1020 email addresses may be verified by the system 1000. The Content and Delivery Engine 1280 may then, in step 5650, send verification email messages to the email addresses and/or corresponding Users 1020 being verified and then, in step 5655, wait for and receive and hyperlink click verifications. Users 1020 may then receive the verification emails click on the security verification hyperlinks and then, in step 5655, these clicks are collected by the Content and Delivery Engine 1280.

If, in decision block 5660, User 1020 security codes are verified (“Yes”), the process 5600 may continue to step 5680. If in decision block 5660, security hyperlinks have not yet been clicked and verified (“No”), the process 5600 may continue to step 5670 whereby Users are notified of the missing verifications and/or they may request additional verification emails be sent. Continuing from step 5670 to decision block 5690, if no additional verification attempts are specified and the process should be stopped (“Yes”), any messaging may be provided to Users 1020 and the process may continue to decision block 5700. If additional verification emails are specified and/or the process 5600 should not stop (“No”), the process may continue to decision block 5695. In decision block 5695, if new verification emails are specified and/or requested by Users 1020 (“Yes”), the process may return to step 5640. In decision block 5696, if no additional verification emails are specified and/or requested (“No”), the process may return to step 5655. In step 5680, databases, for example User Databases 1200 and/or Entity 1260 databases and/or ASP Databases 1272 are updated with the email validation results. In decision block 5700, if User 1020 call sessions are in progress (“Yes”), the process 5600 may RETURN to the next step in the previous process flow, just after the “G” sub-process was specified. If, in decision block 5700, User 1020 calls are not in session (“No”), the example process 5600 may END.

Next, FIG. 5 is a flow diagram of an example process 5800 for providing Users 1020 with content and/or advertising from a SN 1240 and/or Entities 1260 via email and/or other channels. While the email channel and communication vehicle may be identified in some examples in this description, the subject technology may create and/or deliver content and/or advertising to a variety of channels, methods, Devices, Apps, etc. For example, User App 1290 interfaces, web pages, online or offline ad networks (including text, links, banners, text ads and/or video), mobile apps, social media profiles, printed communications, kiosks, TV screens and/or other channels and/or methods may be used. In step 5810, the Content and Delivery Engine 1280 may be initiated and, in step 5820, the User Database 1200 and/or other databases are read and/or consulted and various rule sets and/or programs and/or settings within the Content and Delivery Engine 1280 may be initiated. In decision block 5830, the Content and Delivery Engine 1280 may determine which Users 1080 may be eligible to receive new content. User 1020 content, as previously described, may consist of a wide range of items, types, combinations and/or formats, for example information, news, incentives, advertising (including text, links, banners, text ads and/or video), account information, phone call information and/or call history and/or any other content, content types and/or formats. Content may include dynamic and/or database driven content and/or elements and/or entire communications may be standardized and/or customized for Users 1020, for groups of Users 1020 and/or for specific Users 1020. Some content and/or communications examples are illustrated in the example interfaces in FIGS. 5A, 5B, which are further described below.

Continuing to look at FIG. 5, in decision block 5830, for Users who may be eligible for content creation and/or delivery (“Yes”), the process may move to step 5840. The Content and Delivery Engine 1280 and/or other parts of the system 1000 may have rules related to generating and/or sending new content to Users 1020, such as sending emails on a regularly scheduled basis, for example daily digests, and/or content delivery may be triggered based on variety of events and/or event types, for example calls placed by Users 1020 to SNPNs 1030. For Users not eligible for content creation and/or delivery (“No”), this example process 5800 may END. In step 5840, the Content and Delivery Engine 1280 may consult the Entity Database 1300 for any Entity 1260 content, including content and/or ads which may have been received via external sources and/or APIs and/or ad networks (for example coupon and/or “deal” networks) and/or offers and/or advertising to include and/or assemble for deliver to eligible Users 1020. In step 5860, the Content and Delivery Engine 1280 creates and/or formats content as specified by rule sets and/or settings and/or other instructions.

If any Users 1020, Entities 1260 and/or content need to have content delivered via Entity ASPs (“Yes” in decision block 5870), Entity Apps 1310 and/or the Content and Delivery Engine 1280 initiate connections to ASPs 1270. In step 5880, assembled and/or formatted content may be delivered to Users 1020 across a variety of forms, channels and/or modes and/or methods, for example, by email, applications, web pages, ad networks, display or text ads, social media profiles, banners, video, text and other/or content forms, channels, methods and/or modes. In step 5890, User Databases 1200, Entity 1260 databases, ASP Databases 1272, etc. may be updated with data, for example email delivery success and results, email bounce information, ad delivery issues, impression and/or click-through rates, application transmission errors and/or failure data and other data and/or information. Then, after step 5890, this example process may END.

Next, FIGS. 6, 6A, 7, 8, 9, and 9A show several example interfaces for some aspects of the subject technology. While specific fictional information is used in these example interfaces, the technology is not limited to the characteristics of this fictional information. For example, while SNPNs and UPNs shown in examples may appear as local phone numbers (for example, not “1-800” and/or toll-free and/or international numbers or other), phone numbers referenced in this application and/or related to the subject technology may be local, toll-free, international and/or other forms and/or formats. For another example, while Entities 1260 shown in examples may be locally-based and/or retail businesses, Entities 1260 may, for example, be nationally-based and/or internationally-based, having any number physical locations and/or no physical locations, and/or may be associated with a variety of type(s) of industries, business types, organization types and/or have other classifications and/or purposes.

FIGS. 6 and 6A show example interfaces illustrating example SN 1240 opt-in processes and/or content and/or features provided to Users 1020 by an example SN 1240, in FIG. 6, and an example Entity 1260, in FIG. 6A. As described previously, Users 1020 may opt-in to SNs 1240 and/or Entities 1260 during calls made to SNPNs 1030 and/or they may opt-in to SNs 1240 and/or Entities 1260 through any other manner of online and/or offline devices, applications, Apps, interfaces, forms, optical scan codes, kiosks, etc. Looking at FIG. 6, an example interface 6500 is illustrated and shows an example opt-in interface and/or process for Users 1020 of the “Anytown Network,” which is a Subscription Network (“SN”) 1240 and local business directory and ad network. Users 1020 may arrive at SN 1240 opt-in interfaces like this one 6500 in a variety of ways and/or paths, including via websites, ecommerce purchase processes, advertisements, optical scans, mobile apps, offline paper forms, forms completed on behalf of Users 1020 by telephone operators and/or other paths and/or methods.

This example opt-in interface 6500 may be displayed to the example User 1020, Jane Smith 6060, across a variety of the devices and/or apps she uses, for example a mobile app, a web browser, a mobile website, etc. The example interface 6500 may be created, managed, hosted and/or advertised by the Anytown Network, which may be considered, for example, a SN 1240 and/or Entity 1260 and the subject technology could also enable dynamically driven logos and/or content to create “white label” versions of the subject technologies and SN 1240 features, for example SN 1240 names, logos, links and other content shown/delivered to Users 1020 and/or Entities 1260. The example interface 6500 may consist of the Anytown Network logo 6510 (for example, dynamically driven in white label examples), an enticing “Sign-up today!” headline 6520 and/or marketing language and/or descriptions of the benefits of joining the network 6530. The next section of the interface 6500 includes entry fields used by the Anytown Network collect User 1020 contact information. In this example 6500, Jane 6060 has entered her first and last name 6540. She has also entered her email address 6550 which may be used by the Anytown Network SN to deliver verification emails, offers and promotions, daily promotions and digests and/or other content. Next, she was asked for and has entered two of her phone numbers, her mobile phone number 6560 and her home phone number 6570. These may serve as her User 1020 phone numbers (“UPNs”) and they may be used to identify her in the future during calls Jane makes to Anytown Network issued phone numbers (“SNPNs” 1030). In this opt-in interface 6500, Jane may also enter additional phone numbers, or UPNs, using the link provided 6580 which may expand or open a new window to allow her to provide additional phone number entry fields. The next paragraph 6590 provides an example of the language the Anytown Network may use to inform the opting-in User of the permissions they are granting, what they are opting-in to receive, how their personal data may be used, as well as if/how they may opt-out and/or other information and/or notices.

In the next part of the interface 6600, a “Cancel” link may be provided to cancel the sign-up page/process and an “Agree & Submit” button used to complete the process and to submit the form. Upon clicking on this button and submission of a completed form, Jane 6060 would be “opted-in” to the Anytown Network. The footer area 6610 of the interface provides links to the Anytown Network Privacy Policy and Terms of Use, which, when opened and read, may provide Users 1020 with additional information about how their personal data may be stored and used, what Users 1020 agree to as part of using the services as well as other service and/or legal notices.

Next, looking at FIG. 6A, an example interface 6700 is illustrated and shows an alternative example opt-in interface and/or process for Users 1020 to opt-in to receive content and/or services from an example local pizza shop and business Entity 1260, Joe Pizza, which is an active advertiser and member of the aforementioned Anytown Network. Many aspects of this interface 6700 are similar to the aspects of the prior interface 6500. Similar headlines 6720, marketing benefits 6730, links and buttons 6810, 6820 are presented and similar User 1020 contact information 6740 may be solicited and collected. However, this interface 6700 may have been created by, hosted by and/or offered by Joe Pizza and/or its designated agencies as a way for its customers and audiences to receive promotions, news and other information, for example by email, directly from Joe Pizza.

While the content on this page is managed under the direction of Joe Pizza, any number and/or combinations of other agencies, hosting companies, applications, ASPs, etc. could program, create, host and/or manage the technology and/or page(s), including, for example the Anytown Network example SN 1240. Additionally, in this interface 6700, Joe Pizza also has an opt-in checkbox and opt-in language 6800, providing “co-registration” and/or providing a way for Joe Pizza's opting-in customers and/or audiences to also opt-in to the Anytown Network. Using the form on this interface 6700, upon checking the checkbox, clicking on the “Agree & Submit” button and submitting a completed form, Jane 6060 would be “opted-in” to both Joe Pizza and Anytown Network. Data from this submitted screen/form, for example User 1020 profiles and/or opt-in information, may be shared and/or transmitted to the Anytown Network example SN 1240 and/or to its designees by a variety of means, for example via Entity Apps 1310, APIs, ASPs, file exchanges and/or other exchange methods. Similar to the prior interface example 6700, Jane's name, email address and UPNs 6740 may all be obtained and used by Anytown Network in all the same ways as if she had opted-in by phone and/or the prior interface example. Entities like Joe Pizza may get a variety of incentives and/or benefits from Subscription Networks 1240, such as Anytown Network, by promoting SN 1240 opt-in to their customers and/or audiences. For example, Entities 1260 may get affiliate revenue, discounts on advertising and/or the ability to build and reach a larger potential customer base. In return, SNs 1240 may generate a larger pool of opted-in Users 1020.

Continuing to FIG. 7, a device interface 7000 illustrating an example User App 1290 for providing Users 1020 with various cross-channel and/or network and/or Entity 1260 opt-in management, settings and/or preferences. Continuing with the example scenario from above examples, Jane Smith 6060 is a User 1020 opted-in to the Anytown Network and is provided with a User App 1290 to manage her account and access a variety of other features and/or functions. The App in the example interface 7000 could be provided by the Anytown Network SN 1240 as a mobile and/or tablet app, a desktop computer software application, a website, a mobile website and/or other devices and/or applications. In the example screen, the greeting and top-right 7020 section indicate that Jane is authenticated and/or “logged-in” to the App. The headline 7030 and opening paragraph 7040 are example descriptions of some of the features and/or benefits using of this part of the App.

The middle table section 7050 is an example of how the SN 1240, Anytown Network, is providing ways for Users 1020 to manage phone numbers that are registered with the SN and ways to opt-in and/or opt-out of services related to those UPNs and calls made to SNPNs 1030. In this example, Jane has two numbers registered, a mobile number 7070 and a home number 7080, and she is provided with an option to add more numbers 7085. Using this example table, Jane may opt-in (indicated with a “Yes” in the 3^{rd} column) or opt-out (changing 3^{rd} column to “No”) one or both of her registered UPN phone numbers. Additionally, using the settings in the 4^{th} column 7060, she may choose to share (marked as “Yes”) or not share (“No”) her Caller ID information when she calls Anytown Network businesses (via SNPNs 1030) from one or more of her registered phones and UPNs. In this example, since she may not want businesses to know her home phone number, she has chosen to change that setting in that column 7060 to “No” so that, when she calls Anytown Network businesses and SNPNs 1030, her Caller ID information will not be shared with them, but, since this number is opted-in to the SN 1240, she may still be identified in her calls and receive all the other features and/or benefits.

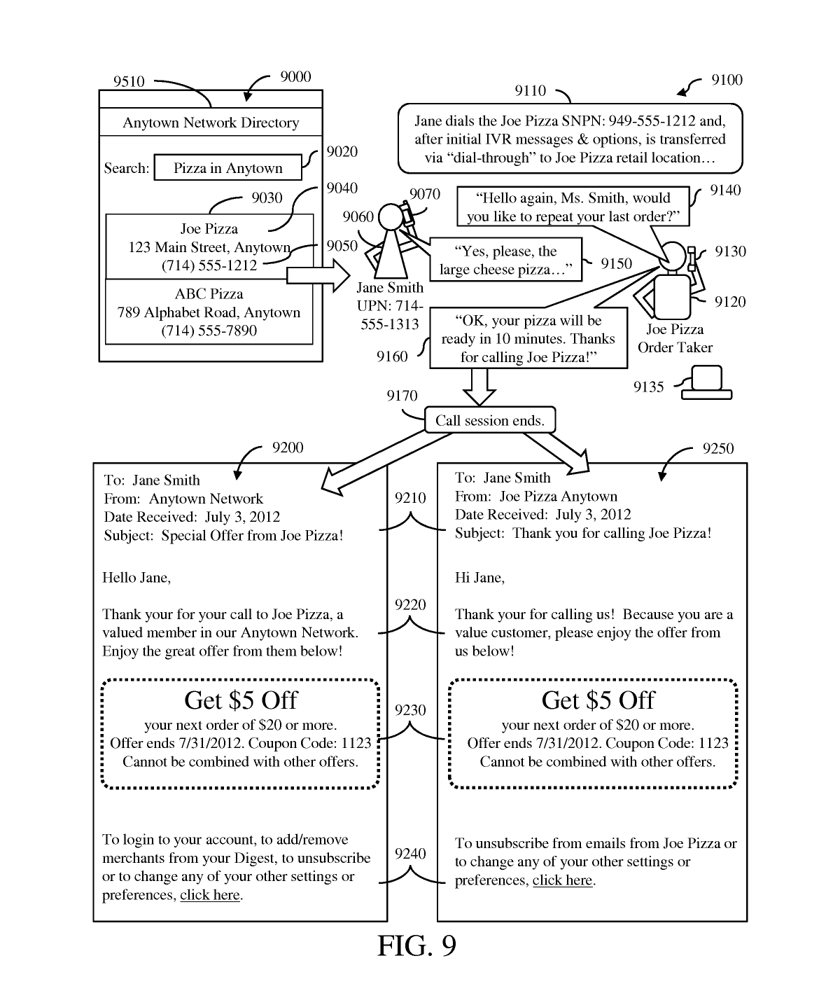

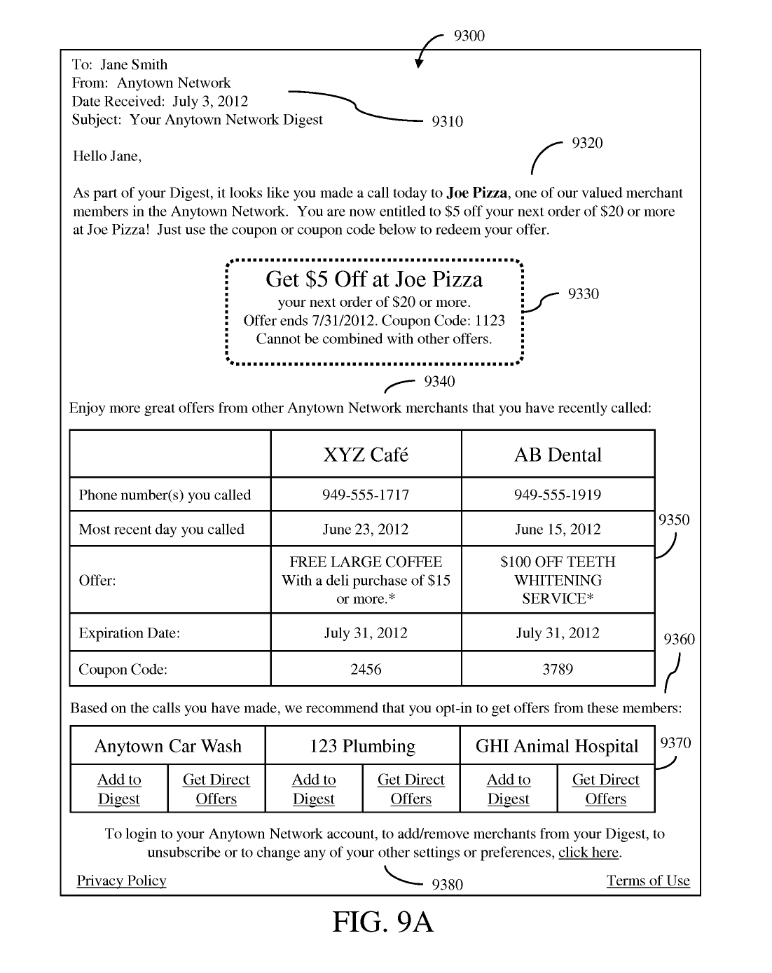

Continuing to look at FIG. 7, the second table 7090 in the example App interface 7000 provides Anytown Network Users 1020 with ways to view and manage history and/or settings related to the member Entities 1260 which Users 1020 have called. Three example Entities 1260 which Jane Smith has called are shown, along with their respective SNPNs 7095 and other settings. These Entities 1260 were added to this table 7090 automatically by the User App 1290 each time Jane called them using their respective SNPNs 7095. Jane is also provided a way to manually add and/or manage other Entities using the link far right 7125. In the example rows, Jane is provided with ways to manage her opt-ins and other settings for each Entity, including which one(s) 7100 (marked with “Yes”) should be included in her personalized and summarized Anytown Network “Digest” content. An example of this Digest is shown in FIG. 9A.

In the next row 7110 of the table 7090, Jane is provided with ways to opt-in (“Yes”) or opt-out (“No”) of receiving stand-alone emails and/or other content specifically related to each Entity 1260 business and/or which may be triggered based on her calls to each SNPN 7095 for each business Entity 1260. An example of one of these stand-alone, specific emails is shown in FIG. 9, interface 6200. In the next row 7120 of the table 7090, Jane is provided with ways to receive (“Yes”) or not receive (“No”) various in-call features and services during calls placed to the SNPNs 1030 of the member Entities 1260. For example, since she is opted-in to the in-call features, when she calls Joe Pizza, she might automatically be offered various discounts or customer service options as she will be recognized by the system 1000 and/or by Joe Pizza staff as being a regular Joe Pizza customer. As another example and as further illustrated in the schematic 6100 in FIG. 9, Jane's past Joe Pizza phone orders may be stored and/or accessed by the system 1000 and/or Joe Pizza phone order takers via Entity Apps 1310 provided to them by Anytown Network. In the second to the last row 7121 in this table 7090, Jane is provided a way to opt-in or opt-out of search engine ads or other text, banner, video or other ads served by various Ad Networks 1276. Some examples of these ads are further illustrated in FIGS. 10, 10A and 10B and described below. In the last row 7122 of the example table 7090 in the example interface 7000, Jane is provided with ways to completely block (marked with “Yes”) offers, in-call features, and other features related to her calls made to each business. In this example 7122, she does not want to receive offers or in-call features from Bob's Used Cars, so this row 7122 is marked with a “Yes” under the Bob's Used Cars column to block offers and features related that specific Entity 1260.

Continuing now to FIG. 8, an interface 8000 is shown illustrating an example Entity App 1310 for providing content management, incentive and/or advertising management; settings and/or preferences management; reporting; and/or payment and/or billing management and/or other features to Entities 1260. This example Entity App 1310 may also be connected, for example via the Anytown Network's example of a system 1000 and/or their example of a SN 1240, to an example of the Entity Database 1300. Information provided and/or collected in this example interface 8000 may be generated from and/or stored in the Anytown Network example of the Entity Database 1300. Joseph Cheese is the example owner of the example local Anytown pizza shop, Joe Pizza, which was described in the previous examples and which is an example member Entity 1260 within the example Anytown Network SN 1240.

The example Entity App 1310 shown in the example interface 8000 has been provided to member Anytown Network businesses to manage their Entity 1260 accounts and/or access a variety of other features and/or functions. This example Entity App 1310 may be provided by the Anytown Network SN 1240 as a mobile and/or tablet app, a desktop computer software application, a website, a mobile website and/or other devices and/or applications. In the example screen, the greeting and top-right 8020 section indicate that Joseph Cheese is authenticated and/or “logged-in” to the App. The headline 8030 and opening paragraph 8040 are example descriptions of some of the features and/or benefits using of this “Account Settings” portion of the App. The next area 8050 provides fields for Joseph to enter and/or update his business contact information, location, etc. Next, a field 8060 to enter and update the Joe Pizza business location phone number is provided. In this example, this is the regular business number that had previously been the customer phone number for the Joe Pizza Anytown retail location. This number 8060 would also be the destination phone number 1032 for calls routed to the business in previously described “dial-through” SNPN 1030 phone call sessions. Next, the primary Joe Pizza SNPN is shown 8070. This SNPN 8070 was issued to Joe Pizza as part of the services (paid or free) provided by Anytown Network to its member Entities 1260. Joe Pizza may advertise this SNPN number, likely in place of their destination number 1032, so that more and more of their customers may take advantage of the services and features offered via the subject technologies. Next, a hyperlink 8080 is provided which, if clicked and used, would provide Joseph and/or other Entities 1260 using this Entity App 1310 with ways to change and/or add other business locations and/or destination business phone numbers 1032 and/or to change and/or add SNPNs 1030. Additional fees for SNPNs 1030 may or may not be charged to Entities 1260 by SNs 1240. In the last part of this example account settings section 8030, a link 8090 which leads to ways to enter and/or update an Entity's products and/services and/or add or update billing information is provided.

Continuing to look at FIG. 8, interface 8000, ways to enter and/or manage customer offers and incentives are provided to Entities in the next section titled “Your Customer Incentives and Offers” 8100. In this section 8100 of the Entity App 1310, Joseph Cheese and other member Anytown Network users may enter one or more offers and/or incentives which may be advertised and/or offered to Anytown Network users. Alternatively, in other examples these Entity offers may be configured and/or collected, edited and/or updated via 3^{rd} parties and/or 3^{rd} party applications, other networks and/or other APIs, for example via ad networks and/or coupon networks and/or other sources. In this example, Joseph Pizza has entered the details 8130 of a $5 off pizza coupon that he would like to be offered to Anytown Network users. A link 8140 is also provided which, if clicked and/or accessed, would allow the example Entity App users to enter more offers.

In various examples, SNs 1240 may charge fees to Entities 1260 related to advertising services such as these. In the last section 8150 of this example interface 8000 showing the example Entity App 1310, ways for Entities 1260 to enter and/or modify their ASP settings are provided. As described previously and illustrated with example Entity C 1268 in FIG. 1, in various examples, Entities 1260 and/or their agencies and/or designees may use 3^{rd} party services and/or email application service providers (“ASPs”) to help them manage their opt-in customer databases, emails, email content and/or email delivery. In this example, Joseph Cheese has entered information on his email ASP, “XYZ Email Monkey,” along with the “token” which would allow the Anytown business App to interface with and/or access the Joe Pizza account within XYZ Email Monkey to exchange data, update opt-in status, add/remove User 1020 subscribers and/or perform other services and/or functions. Finally, a link is provided that, when accessed, provides Joseph Cheese and other Anytown Network business App users with ways to add, update and/or modify their other customer database(s) and/or email settings. For example, this area may provide Entities 1260 with other options for providing data exchanges, for example via in-house Entity 1260 databases, as illustrated previously in FIG. 1 with example Entity B 1264 and its in-house Entity B Database 1266.

Next, FIG. 9 shows schematics and interfaces illustrating example processes and/or content and/or advertising being triggered and/or generated and/or delivered to aforementioned User 1020, Jane Smith 9060, across a variety of content delivery channels and/or devices and/or methods, for example email. These examples of features and content may have been created via examples of the system 1000 and processes previously described, for example the environments and processes illustrated in FIGS. 1, 2, 4, 4D, 4D, 4E, etc. In the first interface 9000, an example local business search performed by Jane Smith is shown whereby she uses a device, such as her computer or mobile phone 9070, to access the Anytown Network Directory website or app 9010, to search for a local business, in this example a pizza place in Anytown 9020. The Anytown Network Directory website or app provides Jane with resulting listings 9030, including a listing for the aforementioned Joe Pizza 9040. As previously mentioned, the phone number listed for Joe Pizza, “714-555-1212” and marked with item 9050, is an example of a “dial-through” SNPN 1030 which, in this example, has been procured, issued and listed by the Anytown Network and its online directory.

Continuing to the next schematic 9100, Jane 9060 is shown calling the Joe Pizza SNPN 9050 she retrieved from the search results in the Anytown Directory found in the prior interface 9000. She is calling to order a pizza 9110. In this schematic, Jane uses her mobile phone 9070 to call the Joe Pizza SNPN 9050. As mentioned previously, the UPN associated with Jane's mobile phone 9070 is a registered with the Anytown Network and opted-in to receive offers and services, including those related to calls made to the Joe Pizza and its SNPN 9050. Via example processes and flows previously described, for example in FIGS. 4D and 4E, after some initial messages and phone tree options played to Jane (via Anytown Network's example use of an IVR and Phone Tree Engine 1160), Jane's call is then transferred via the “dial-through” process to the example destination Joe Pizza phone number 8060 and phone devices 9130 for the Joe Pizza retail store in Anytown. Through her Anytown Network example User App 1290 settings, Jane had previously agreed to share her UPN and Caller ID with Joe Pizza when she calls their SNPNs. The Joe Pizza order taker 9120 answers Jane's call using the store's telephone device 9130. In this example scenario and schematic 9100, the Joe Pizza order taker 9120 has an Anytown Network Entity App 1310 running on a computer terminal 9135 which matches Jane's UPN and/or her Anytown Network account and retrieves her past Joe Pizza orders. While this example 9100 uses a computer terminal 9135 and/or Entity App 1310 to track customer order history via UPNs, this is just one example of the subject technology. Entity computer terminals and/or Entity Apps 1310 and/or User Apps 1290 may not be needed and/or used in other examples. Alternatively, the subject technology may be utilized used within regular POTS/PSTN phone calls made by Users 1020 to dial-through or subscribe-only SNPNs 1030, without use of User Apps 1290, Entity Apps 1310, Entity 1260 and/or User 1020 computers, etc. Continuing in the example in this schematic 9100, the order taker 9120 asks Jane 9060 if she would like to repeat her past order 9140, she says “Yes” 9150 and the order and the order taker gives her a time it will be ready 9160 and then Jane's call to Joe Pizza ends 9170.

Continuing in FIG. 9, in interfaces 9200 and 9250, illustrations of example user interfaces are shown to represent example content delivered to Jane 9060 after her call with Joe Pizza ends in the prior schematic 9100. Based a variety of factors, for example, settings in Jane's Anytown Network account, settings in the Anytown Network SN 1240, and/or the Joe Pizza Entity 1260 settings, these content messages may be delivered to Jane 9060 via various methods and channels, for example via email, a mobile App, her User App account and/or a variety of other channels and/or methods and/or formats, including dynamic and/or static content.

In various examples, either one or both of these content messages may or may not be delivered, simultaneously or in any order, triggered based on events and/or at scheduled intervals. In the first example content message 9200, an email has been created, formatted and sent from Anytown Network (via their example use of a Content and Delivery Engine 1280) to Jane 9060 at her email address on file in her Anytown Network account (via their example use of a User Database 1200). In the second example content message 9200, an email has been created, formatted and sent to Jane 9060 from Joe Pizza and their email ASP and email ASP database. Both message examples 9200, 9250 and their contents were created, formatted and/or delivered and information was exchanged across their system 1000 components (for example with the email ASP) utilizing features provided by Anytown Network's example of the subject technology and/or system 1000. In these examples, the emails could have been either automatically triggered due to Jane's phone call to Joe Pizza and their SNPN 1030 and/or scheduled for delivery, such as on a daily basis. In this example, SNPN 1030 phone call events may be stored in various Anytown Network provided examples of User Databases 1200, IVR and Phone Tree Engines 1160 and/or Email ASP Databases 1272. In the example content messages 9200, 9250 the email header information is shown 9210, followed by a personalized and brief introduction message 9220, which contains some dynamic content. Next, a Joe Pizza $5 off coupon 9230 has been created and provided in Jane's email message and generated using content from the offer previously submitted by Joseph Cheese on behalf of Joe Pizza, as shown in the example in FIG. 8, item 8150. The next content section 9240 provides ways for Jane to update her accounts with Anytown Network and/or Joe Pizza, for example to opt-out of emails, and/or other features.

Continuing to FIG. 9A, another example content message interface 9300 is illustrated, showing content provided, in this example, via email, by the aforementioned Anytown Network (a previously described example SN 1240) to the email address registered by the aforementioned Jane Smith (a previously described example User 1020). Like the previous examples, based a variety of factors, for example, settings in Jane's Anytown Network account, settings in the Anytown Network SN 1240, and/or the Joe Pizza Entity 1260 settings, these content messages may be delivered to Jane 9060 via various methods and channels, for example via email, a mobile App, her User App account and/or a variety of other channels and/or methods and/or formats, including dynamic and/or static content. In various examples, any of these content messages may or may not be delivered, simultaneously or in any order, triggered based on events and/or at scheduled intervals.

The example message 9300 is an example of a regularly scheduled “digest” email sent to Anytown Network users, like Jane, as part of their being a registered and opted-in example Users 1020 in the Anytown Network example SN 1240. In this example, Anytown Network may send regularly scheduled Digest emails, for example every day at the same time, utilizing their example of the Content and Delivery Engine 1160. After the email header information 9310 and introduction paragraph section 9320, based on her recent call to Joe Pizza, Jane is provided with a Joe Pizza $5 Off coupon 9330 similar to the one previously described in FIG. 9. Below the coupon, a brief description 9340 and table 9350 is shown, providing Jane Smith with offers and information related to other businesses that are members of the Anytown Network and to whom Jane has recently called using her registered UPNs and phones by dialing the businesses' respective Anytown Network SNPNs. The offers provided to Jane in this example table 9350 may have been collected, assembled and distributed using example methods and systems similar to those related to the Joe Pizza coupon example described previously, whereby these example businesses used the example Anytown Network Entity App 1310 to enter their offers, etc. and which may be stored in the Anytown Network example of an Entity Database 1300. The example businesses shown and their respective example offers, in various examples, may be assembled and/or provided and/or may be received, read, and/or redeemed in a variety of different ways and/or formats, for example redeemed via “QR Codes,” printable coupons, mobile apps, coupon apps, secure and/or personalized coupons, bar codes and/or other methods and/or systems.

Continuing to look at FIG. 9A, example interface 9300, below table 9350 with example offers, another description section 9360 and table 9370 is shown with example content providing Jane Smith with “recommended” Anytown Network member businesses (examples of other Entities 1260) to which Jane should consider opting-into and/or related to which she may receive offers and other content. These example recommendations may have been produced via Anytown Network's example of their Content and Delivery Engine 1280 using a variety of indexing and/or recommending and/or user preference techniques, for example using history from Jane's phone calls, and/or using other preferences and/or calls made by other Anytown Network users (Users 1020). In the example recommendation table 9370, Jane is provided ways to add one or more of the example businesses to her Digests and/or to opt-in to direct and/or specific offers for one or more of them. In the next example content section 9380, Jane is provided with a hyperlink as an example way to add and/or modify the content and/or other settings of her Anytown Network Digests, for example to opt-out and/or to add/change merchants, etc. After opening the link in this example content section 9380, after Jane has authenticated and/or logged-in to her account within the Anytown Network User App, she may then see an interface similar to the example interface 7000 shown in FIG. 7.

Continuing now to FIG. 10, this shows a flow diagram of an example process 10000 for providing Users 1020 with device, application and/or browser cookies to enable Entity 1260 and/or SN 1240 advertising and/or content to be distributed and displayed to Users 1020 across their various channels, devices, apps and/or Internet browsers. Before the start of this process 10000, Users 1020 may need to have been logged-into and/or “authenticated” by the User App 1290. In step 10010, Users 1020 arrive at various User App 1290 interfaces or pages. In step 10020, the User App 1290 consults the User Database 1200 for User 1020 opt-in and content preferences. Next, in decision block 10030, the User App 1290 determines whether or not Users 1020 are eligible to receive a “cookie” identifier code that will enable receipt of future advertising via Ad Networks 1276. These cookies may be comprised of small pieces of computer programming code commonly used within various devices, applications, and/or Internet browsers to store identifying information and/or other information or preferences. Cookies created and issued by User Apps 1290 within the SN 1240 may be later accessed and in the information within them may be retrieved by Ad Networks 1276 so that targeted and/or opt-in advertising could be presented to those Users 1020 based on their SN 1240 account preferences, phone call history, and/or other information. Examples of how these cookies may be used are further illustrated in FIGS. 10A and 10B and described below.

Continuing in FIG. 10, in decision block 10030, if Users 1020 are determined to not eligible (“No”), for example because they have opted out of this feature, this process may END. If Users 1020 are determined to be eligible (“Yes”), the process may move to step 10035 where the User App 1290 may check for existing SN 1240 cookies stored on their devices and/or browsers. In decision block 10040, if no existing cookies are found and may need to be issued (“Yes”), the process may move to step 10050. If existing SN 1240 cookies are found and do not need to be issued (“No”), the process may skip to step 10060. In step 10050, SN 1240 cookies may be created and issued to the devices and/or browsers of the Users 1020. In step 10060, the cookie IDs may be linked, for example, with user IDs associated with User 1020 accounts in the SN 1240, and/or linked with other information, such as preferred Entities 1260 (such as Joe Pizza) and/or categories of Entities 1260 (such as “local restaurants”) for which these Users 1020 may be targeted to receive advertising. Ad preferences linked to and/or stored in these cookies may be based upon User 1020 call history to SNPNs 1030 and/or a variety of other factors and/or information. In steps 10070 and 10080, some of this information linked to cookies, cookie IDs and/or user IDs and preferences may also be transmitted to other internal or external databases, such as Ad Networks 1276 to further enable future advertising displays to these Users 1020. Information about how to read these cookies and other instructions could also be transmitted to Ad Networks 1276. After step 10080, this process 10000 may END.

Continuing now to FIGS. 10A and 10B, these generally are device interfaces illustrating example advertising being triggered via cookies and displayed to users of devices and/or Internet browsers while using search engines or browsing other content. In the device interface 10500 shown in FIG. 10A, a User 1020, in this case the aforementioned Jane Smith, visits an Internet search engine to look for “Anytown lunch specials” 10510. Jane has pressed or clicked on the “Submit” button 10515 and received some search results 10530 including various web pages related to her search. In addition, an Ad Network 1276 run by this search engine or enlisted by this search engine to serve advertising is able to read the previously issued Anytown Network cookie (using a process similar to that described 10000 in FIG. 10) which is stored on Jane's device or browser. Reading the information in this cookie, the Ad Network 1276 is able to determine that Jane is opted-in to receive text ads from Joe Pizza (as previously determined by the SN 1240 based on her call history and preferences) when combined with searches like her “Anytown lunch specials” keyword search. This determination by the Ad Network 1276 has triggered a sponsored text ad 1520 from Joe Pizza, in this case supplied via content originating from the Anytown Network Entity Database 1300 and transmitted to the Ad Network 1276 for display.

Continuing in FIG. 10B, this shows another example device interface 10700, application or browser window in which the aforementioned Jane Smith is shown accessing a content page hosted by The Anytown Tribune. In this example, The Anytown Tribune has likewise enlisted an Ad Network 1276 to supply advertising, in this case a banner ad 10710. Because the Ad Network 1276 may access and read the information in Jane's cookie issued to her device or browser previously by Anytown Network, this Ad Network 1276 may, like the aforementioned example, also be able to determine that Jane is eligible to receive ads from Joe Pizza and/or the Anytown Network. Thus, the Joe Pizza display ad 10710, created using the offer supplied by the Anytown Network via its Entity Database 1300, is displayed to Jane Smith on this page 10700.

The figures, descriptions, and/or examples of the subject technology and/or present disclosure and/or invention herein and/or above are meant to be instructive and/or illustrative of the invention. As these examples of the invention are detailed, described and/or illustrated, various modifications and/or adaptations of the methods, processes and/and systems may become apparent to those skilled in the art and/or related arts. All such modifications, adaptations, or variations which draw from or rely upon these descriptions, illustrations and/or instructional content of the invention are within the scope and spirit of the invention. The above drawings and descriptions should not be considered as limiting and readers acknowledge that the example methods, processes and/or systems, as described and illustrated herein are only examples and do not limit possible other example methods, systems and/or processes of the invention. The invention is in no way limited to the specifics of any particular embodiments and examples disclosed herein. For example, the terms “aspect,” “example,” “preferably,” “preferred,” “alternative,” “alternatively” and the like denote features that are preferable but not essential to include in embodiments of the invention. In addition, details shown or disclosed with respect to any one aspect of the invention may be used with other aspects of the invention. Additional elements may be added to various aspects of the invention and some disclosed elements may be subtracted from various aspects of the invention without departing from the scope of the invention. Many other variations are possible which remain within the content, scope and spirit of the invention, and these variations would become clear to those skilled in the art after perusal of this application.

What is claimed is:

1. An opt-in system, comprising:
a subscription network including at least tangible computing elements;
one or more interfaces for users to access the subscription network and to provide information for receipt by at least one of a plurality of entities that interact with or operate the subscription network; and
one or more interfaces between the subscription network and the plurality of entities that interact with or operate the subscription network;
wherein the information received by a first entity that interacts with or operates the subscription network is used to deliver a communication, information or offer to at least one of the users from a second entity that interacts with or operates the subscription network, with the first entity different from the second entity.

2. An opt-in system as in claim 1, wherein the one or more interfaces for the users permit the at least one of the users to opt-in to receive the communication, information or offer from the second entity.

3. An opt-in system as in claim 2, wherein the communication, information, or offer delivered to the at least one of the users who opt-in comprises a phone number.

4. An opt-in system as in claim 1, wherein the one or more interfaces for the users are provided over the Internet or a computer network other than the Internet.

5. An opt-in system as in claim 1, wherein the one or more interfaces for the users are provided over a telephone device.

6. An opt-in system as in claim 5, wherein the one or more interfaces for the users to access the subscription network comprise an interface that transfers the at least one of the users to a destination phone number.

7. An opt-in system as in claim 5, wherein the at least one of the users provides the information for receipt by the at least one of a plurality of entities that interact with or operate the subscription network by making a telephone call, and wherein the provided information includes an identified phone number from which the at least one of the users calls.

8. An opt-in system as in claim 1, wherein the one or more interfaces for the users are provided through one or more application service providers different from the plurality of entities that interact with or operate the subscription network.

9. An opt-in system as in claim 1, wherein the one or more interfaces between the subscription network and the plurality of entities that interact with or operate the subscription network are provided over the Internet or a computer network other than the Internet.

10. An opt-in system as in claim 1, wherein the one or more interfaces between the subscription network and the plurality of entities that interact with or operate the subscription network are provided through one or more application service providers different from the plurality of entities that interact with or operate the subscription network.

11. An opt-in system as in claim 1, wherein the communication, information or offer is delivered to the at least one of the users in a separate communication from a communication in which that one of the users accessed the subscription network.

12. An opt-in system as in claim 1, further comprising a database of information provided by the users, wherein the database includes at least the information received by the first entity that interacts with or operates the subscription network and is used to deliver the communication, information or the offer from the second entity that interacts with or operates the subscription network.

13. An opt-in system as in claim 12, wherein the database is accessed by the first entity, the second entity, or both through one or more application service providers different from the plurality of entities that interact with or operate the subscription network.

14. An opt-in system as in claim 12, wherein the one or more interfaces for the users permit at least some of the users to modify those users' information in the database.

15. An opt-in system as in claim 1, further comprising a database of communications, information, or offers from which the communication, information or offer delivered to the at least one of the users is derived.

16. An opt-in system as in claim 1, wherein the one or more interfaces for the users provide for verification of the information provided by at least some of the users.

17. An opt-in system as in claim 1, wherein the communication, information, or offer delivered to the at least one of the users comprises a cookie that enables the second entity to personalize the communication, information or offer.

18. A method of providing access to a subscription network that permits at least one user to opt-in to receive communications, information or offers from entities that interact with or operate the subscription network, comprising the steps of:
providing one or more interfaces to the subscription network for at least one user, at least one of a plurality of entities that interact with or operate the subscription network to communicate with the at least one user, or both;
receiving information provided by the at least one user for receipt by at least a first entity of the plurality of entities that interact with or operate the subscription network; and
providing the information for receipt by at least a second entity of the plurality of entities that interact with or operate the subscription network, with the second entity different from the first entity.

19. A method as in claim 18, wherein the one or more interfaces are provided over the Internet, a computer network other than the Internet, a telephone device, or some combination thereof.

20. A method as in claim 18, wherein the one or more interfaces to the subscription network for the at least one user comprise an interface that transfers the at least one user to a destination phone number.

21. A method as in claim 18, wherein the information provided by the at least one user is received in the form of an identified phone number from which the at least one user calls.

22. A method as in claim 18, further comprising the steps of:
accessing a database of information provided by the at least one of the user; and
generating, from the database, the information for receipt by at least the second entity of the plurality of entities that interact with or operate the subscription network.

23. A method as in claim 18, wherein the one or more interfaces are provided by or through the first entity, the second entity, one or more subscription network operators, one or more application service providers, one or more advertising services, one or more advertising networks, or some combination thereof.

24. A method of permitting at least one user to opt-in to receive communications, information or offers from entities that interact with or operate a subscription network, comprising the steps of:
receiving information from the at least one user through an interface to the subscription network, the information for receipt by at least a first entity of the plurality of entities that interact with or operate the subscription network to communicate with users; and
transmitting at least one of the communications, information or offers from a second entity that interacts with or operates the subscription network to the at least one user, with the first entity different from the second entity.

25. A method as in claim 24, wherein the information received from the at least one user opts the user into receiving the at least one of the communications, information or offers from the second entity.

26. A method as in claim 24, wherein the at least one of the communications, information or offers delivered to the at least one user who opts-in comprises a phone number.

27. A method as in claim 24, wherein the interface to the subscription network comprises an interface that transfers the at least user to a destination phone number.

28. A method as in claim 24, wherein the information received from the at least one user is received in the form of an identified phone number from which the at least one user calls.

29. A method as in claim 24, further comprising the steps of:
accessing a database of information provided by the at least one user;
generating, from the database, the at least one of the communications, information or offers sent to the at least one user.

30. A method as in claim 24, wherein the interface to the subscription network is provided by or through the first entity, the second entity, one or more subscription network operators, one or more application service providers, one or more advertising services, one or more advertising networks, or some combination thereof.
